(19) United States
(12) Patent Application Publication
(10) Pub. No.: US 2026/0087871 A1
(43) Pub. Date: Mar. 26, 2026

(54) INFORMATION PROCESSING DEVICE, INFORMATION PROCESSING METHOD AND INFORMATION PROCESSING SYSTEM

(71) Applicant: MIXI, Inc., Tokyo (JP)

(72) Inventor: Koji ISHII, Tokyo (JP)

(73) Assignee: MIXI, Inc., Tokyo (JP)

(21) Appl. No.: 19/110,913

(22) PCT Filed: Aug. 21, 2023
(86) PCT No.: PCT/JP2023/029989

§ 371 Date: Mar. 12, 2025

(30) Foreign Application Priority Data
Sep. 13, 2022 (JP) 2022-145004

(51) Int. Cl. G07F 17/32; G06F 3/0482; G06F 3/04845; G06Q 50/34

(52) U.S. Cl. CPC G07F 17/3211; G06F 3/0482; G06F 3/04845; G06Q 50/34; G07F 17/3288

(57) ABSTRACT

An information processing device includes: a processor; and a storage, in which the storage stores information about one or more races bet by a first user and information about one or more races bet by a second user, the processor causes a terminal apparatus of the first user to display a first screen, the first screen displaying a list of the one or more races bet by the first user and including one or more display regions that respectively display one or more races bet by the first user, and controls at least one of a display form and a display position of the one or more display regions based on whether the one or more races bet by the first user are bet by the second user in the information stored in the storage.

### CROSS REFERENCE TO RELATED APPLICATIONS

This application claims the priority of Japanese Patent Application No.2022-145004, the entire disclosure of which is incorporated herein by reference.

### TECHNICAL FIELD

The present invention relates to an information processing device, an information processing method and an information processing system.

### BACKGROUND ART

In the related art, an apparatus that receives from a first user belonging to a certain group a bet on a betting content that is specified in accordance with a betting content of a second user belonging to the same group is known (e.g., PTL 1). The betting content is, for example, a betting target, a betting method and the amount of a predetermined value designated by a user or a forecaster when placing a bet.

### CITATION LIST

### Patent Literature

PTL 1: JP2021-125268A

### SUMMARY OF INVENTION

### Technical Problem

When placing bets together with another user, it becomes more difficult to identify the user who previously placed the bets together as the number of bets performed increases.

The present invention provides a technique of configuring a graphical user interface (GUI) with which whether the race bet by the user is bet by other users can be easily recognized.

### Solution to Problem

An information processing device according to an aspect of the present invention includes: a processor; and a storage, in which the storage stores information about one or more races bet by a first user and information about one or more races bet by a second user, the processor causes a terminal apparatus of the first user to display a first screen, the first screen displaying a list of the one or more races bet by the first user and including one or more display regions that respectively display one or more races bet by the first user, and controls at least one of a display form and a display position of the one or more display regions based on whether the one or more races bet by the first user are bet by the second user in the information stored in the storage.

### Advantageous Effects of Invention

According to the present invention, it is possible to provide a technique of configuring a (GUI) with which whether the race bet by the user is bet by other users can be easily recognized.

### BRIEF DESCRIPTION OF DRAWINGS

FIG. 1 is a diagram illustrating an example of a configuration of an information processing system according to an embodiment.

FIG. 2 is a diagram illustrating an example of a hardware configuration of a server and a terminal.

FIG. 3 is a diagram illustrating an example of a functional block configuration of a server.

FIG. 4 is a diagram illustrating an example of data managed as a user management DB.

FIG. 5 is a diagram illustrating an example of data managed as a group management DB.

FIG. 6 is a diagram illustrating an example of data managed as a race history management DB.

FIG. 7 is a sequence diagram illustrating an example of a processing procedure executed by the information processing system.

FIG. 8 is a diagram illustrating an example of a bet screen displayed on a terminal apparatus.

FIG. 9 is a diagram illustrating an example of bet information data transmitted from the terminal apparatus.

FIG. 10 is a diagram illustrating an example of a bet screen displayed on the terminal apparatus.

FIG. 11 is a diagram illustrating an example of response information data transmitted from the terminal apparatus.

FIG. 12 is a sequence diagram illustrating another example of the processing procedure executed by the information processing system.

FIG. 13 is a diagram illustrating an example of a bet screen displayed on the terminal apparatus.

FIG. 14 is a diagram illustrating a first example of a list of race history information.

FIG. 15 is a diagram illustrating a second example of a list of race history information.

FIG. 16 is a diagram illustrating an example of a display of detailed information of race history information.

FIG. 17 is a diagram illustrating an example of the other user selection screen.

FIG. 18 is a diagram illustrating a display screen example of race history information related to another user.

FIG. 19 is a diagram illustrating another display screen example of race history information related to another user.

FIG. 20 is a diagram illustrating a display screen example of a list of race venues.

FIG. 21 is a diagram illustrating an example of rearrangement of display regions of race venues.

FIG. 22 is a diagram illustrating an example of a display screen that displays information about a race conducted at a specific race venue.

FIG. 23 is a diagram illustrating a display screen example of information about a race bet by the first user and a betting content.

FIG. 24 is a sequence diagram illustrating an example of a processing procedure that is executed when displaying information related to another user.

FIG. 25 is a sequence diagram illustrating an example of a processing procedure that is executed when displaying information related to another user.

### DESCRIPTION OF EMBODIMENTS

Embodiments are described below with reference to the drawings. In the drawings, identical or equivalent components are marked with the same symbols, and when explanations concerning identical or equivalent components are duplicated, they are omitted as appropriate. The embodiments described below do not limit the contents described in the claims. Also, not all of the configurations described in the embodiments are necessarily essential to the present disclosure. The configurations described in the embodiments may be omitted as appropriate as long as they provide the functions described in this disclosure.

### System Configuration Example

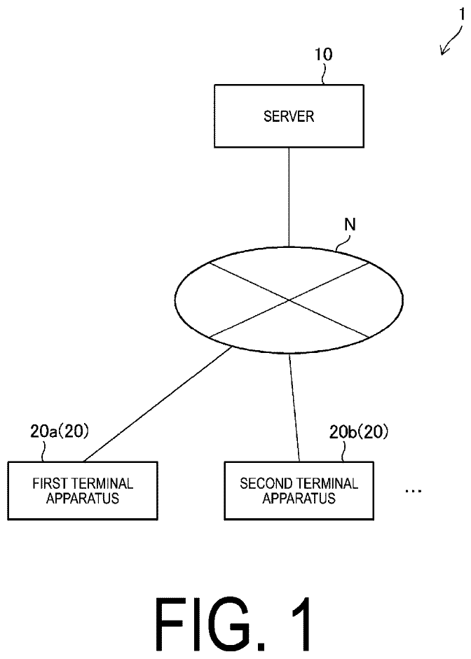

FIG. 1 is a diagram illustrating an example of a system configuration of an information processing system 1 according to an embodiment. The information processing system 1 illustrated in FIG. 1 includes a server 10 and a plurality of terminal apparatuses 20. FIG. 1 illustrates a first terminal apparatus 20a and a second terminal apparatus 20b as the plurality of terminal apparatuses 20. Note that, the number of the terminal apparatuses 20 provided in the information processing system 1 is not limited to two, and may be three or more. In addition, in this specification, when the first terminal apparatus 20a and the second terminal apparatus 20b are not discriminated from each other, they are collectively referred to simply as “terminal apparatus 20”.

The server 10 and the terminal apparatus 20 are connected to each other for information communication via a communication network N such as the Internet, intranet, wireless LAN (Local Area Network), and mobile communication.

The server 10 functions as the information processing device according to the present disclosure. The server 10 may be composed of one or a plurality of physical servers or the like, or composed using a virtual server that operates on a hypervisor (hypervisor), or, composed using a cloud server.

The terminal apparatus 20 is a terminal apparatus used by the user to use the service provided in the information processing system 1. The terminal apparatus 20 is a mobile phone (including smartphones), a tablet terminal, a PC (Personal Computer) or the like, for example.

In the information processing system 1 according to the present embodiment, the user can place a bet on a betting target selected by their own using a predetermined value in various competitions. The user places a bet using the terminal apparatus 20, for example. The server 10 executes various processes such as management of bet information of the user, response information of the user, a predetermined value owned by the user, and payout (such as payout amount) corresponding to results of competitions in various competitions. The predetermined value is money or points used for betting, details of which are described below.

Note that, betting and payout of the predetermined value may be executed by a server managed or operated by the organizer or operator of the race, instead of the server 10, for example. In this case, the server 10 may transmit and receive a variety of information through communication with the server managed or operated by the organizer or operator of the race.

In this specification, the competition is bicycle racing, horse racing, boat racing, auto racing, soccer, futsal, baseball, softball, basketball, volleyball, handball, rugby, badminton, table tennis, billiards, bowling, dodgeball, boxing, wrestling, professional wrestling, track and field, or the like, for example. Competitions in the present embodiment include any event of a competition for superiority among a plurality of contestants (including teams, athletes, and animals). In the present embodiment, the competition is described as a race in which contestants compete for time or rank in order to reach a goal. Therefore, in the following description, the word “race” may be read as “competition” as appropriate.

Bet information represents information about a race bet by the user. The bet information includes information about a race itself, for example. The information about a race itself includes the name, location, date and time, content of the competition, contestants, and race number of a race bet by the user, and the like for example. In addition, bet information includes at least one of the betting content and bet outcome. The betting content includes the betting target, betting method (betting system), bet amount, odds and the like. The bet outcome is information about whether the bet has been successful or not. The bet outcome may be a result indicative of only a case being successful, or a result indicative of both a case of being successful and a case of not being successful.

The betting target is a target on which a predetermined value is bet, and in the present embodiment, the contestants of a race are betting targets. For example, in a race in which the first to fifth contestants compete, each of the first to fifth contestants can be a betting target.

The betting method is a method of placing (betting) a predetermined value on a betting target. The betting method includes win, show, exacta, trifecta, trio, and the like, for example. Win is a method involving predicting the betting target that will finish in first place in the race and placing a bet of a predetermined value on that prediction. Show is a method involving predicting a betting target that will finish in the top three (first to third place) and placing a bet of a predetermined value on that prediction. Exacta is a method involving predicting the betting targets that will finish in first and second place in the exact order, and placing a bet of a predetermined value on that prediction. Quinella is a method involving predicting the two betting targets that will finish in first and second place, regardless of the order, and placing a bet of a predetermined value on that prediction. Trifecta is a method involving predicting the betting targets that will finish in first, second, and third place in the exact order, and placing a bet of a predetermined value on that prediction. Trio is a method involving predicting the three betting targets that will finish in the top three positions (1st to 3rd place), regardless of the order, and placing a bet of a predetermined value on that prediction. The betting methods according to the present embodiment may also include other betting methods than those mentioned above. Additionally, there are competitions such as football pools where the bet is simply placed on which team will win without a specific betting method.

The bet amount is the size of a predetermined value to be placed (bet) on a specific betting target by a specific betting method. The predetermined value may be money or points. The point may also be used for a predetermined service or game, in addition to betting. In addition, the point may be a point that can be received by the user who plays predetermined service or game free of charge in the predetermined service or game (free point), or a point that can be received in exchange for payment of money (i.e., by paying a fee) in the predetermined service or game (paid point), for example. The predetermined value may be simply referred to as “value”.

Odds are multipliers of refunds, and are numerical values that indicate how many times the value of the bet (money or points) will be refunded if the bet has been successful. The odds are determined, for example, according to the official odds (odds set by the race organizer) of the actual race being held. In this case, the odds can change in real time depending on the user's own or other users'betting. The odds may be calculated by a known method of determining dividends, such as the pari-mutuel or bookmaker method, or by any other method.

The response information represents a response to bet information. The response information may be a response from a user other than the user who has placed a bet corresponding to bet information, or a response from the user who has placed a bet. In addition, the response information includes a further response to a response to another user. That is, the response information may include any responses related to bet information.

Response information includes any form of response. For example, the response includes comments, evaluation responses and betting actions. The comments are textual responses. The evaluation responses are responses such as “like” that evaluate bet information, for example. An evaluation response includes not only an evaluation of the bet information as good or bad, but also a response by pressing a pictogram indicating facial expression, a button indicating confirmation, or the like. Betting actions are actions of placing a bet on the same race as the race related to bet information. The betting actions include both voluntary bet, in which the bettors select the betting target and betting method by their own, and bandwagon bet, in which bettors place a bet on the same target as the betting target in the bet information. Specifically, the bandwagon bet may be a bet with the same betting target and betting method as bet information.

### Hardware Configuration

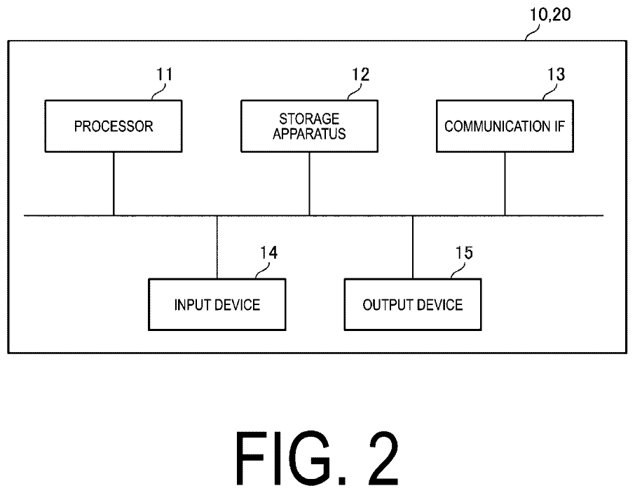

FIG. 2 is a diagram illustrating an example of a hardware configuration of the server 10 and the terminal apparatus 20. The server 10 and the terminal apparatus 20 include a processor 11 such as a CPU (Central Processing Unit) or a GPU (Graphical Processing Unit), a storage apparatus (storage) 12 such as a memory, a HDD (Hard Disk Drive) and/or a SSD (Solid State Drive), a communication IF (Interface) 13 that performs wired or wireless information communication, an input device 14 that receives an inputting operation, and an output device 15 that outputs information. The input device 14 is a keyboard, touch panel, mouse and/or microphone, for example. The output device 15 is a display and/or speaker, for example.

### Functional Block Configuration

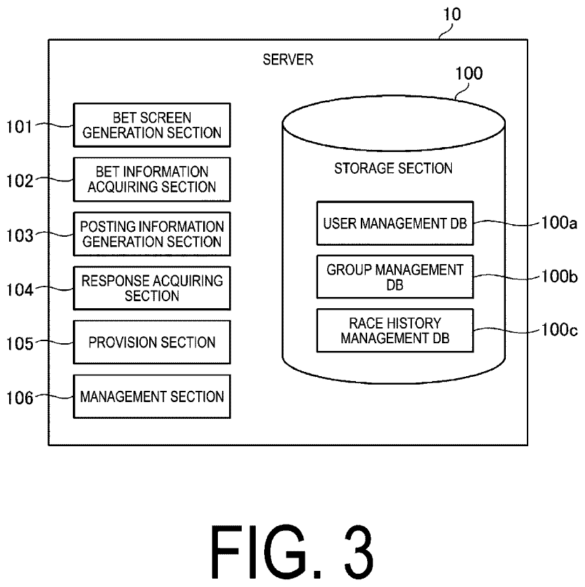

FIG. 3 is a diagram illustrating an example of a functional block configuration of the server 10. The server 10 includes a storage section 100, a bet screen generation section 101, a bet information acquiring section 102, a posting information generation section 103, a response acquiring section 104, a provision section 105, and a management section 106. The storage section 100 can be implemented using the storage apparatus 12 provided in the server 10. In addition, the bet screen generation section 101, the bet information acquiring section 102, the posting information generation section 103, the response acquiring section 104, the provision section 105 and the management section 106 can be implemented when the processor 11 of the server 10 executes a program stored in the storage apparatus 12. This program can be stored in the storage medium. The storage medium storing the program may be a non-transitory computer readable medium. The non-transitory storage medium is not limited, but may be a storage medium such as a USB (Universal Serial Bus) memory or a CD-ROM (Compact Disc Read Only Memory), for example.

The storage section 100 stores a user management DB100a that manages a variety of information related to the user, a group management DB100b that manages a variety of information related to a group including a plurality of users, and a race history management DB100c that manages a variety of information related to past races.

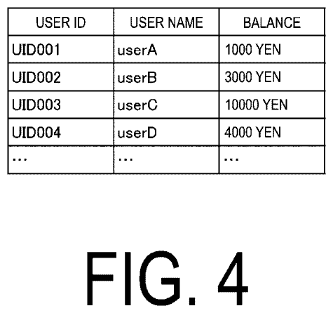

FIG. 4 is a diagram illustrating an example of data managed as the user management DB100a. The user management DB100a manages the user ID, the user name, and the balance as information about the user as illustrated in FIG. 4, for example. The user ID is an identifier for uniquely identifying the user in the server 10. The user name is the name of the user. The user name is the real name or nickname input by the user at the time of registration, for example. The balance is the amount of a predetermined value owned by each user.

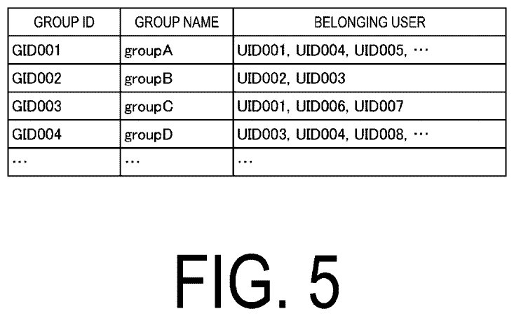

FIG. 5 is a diagram illustrating an example of data managed as the group management DB100b. Here, a group is a collective composed of a plurality of users. The user can form a group with other users. Each of a plurality of users belonging to the same group can share information, and interact with each other, for example, by chatting, for example. For example, each of the plurality of the users belonging to the same group can share bet information about their bets. In addition, the user can make a response to bet information of other users belonging to the same group, for example.

As illustrated in FIG. 5, the group management DB100b manages the group ID, group name, and users belonging to the group as information about the group, for example. The group ID is an identifier for uniquely identifying the group in the server 10. The group name is the name of the group. The group name is a name input by one user belonging to the group (e.g., the leader or administrator of the group) when creating the group, for example. The belonging user is a user belonging to each group. As illustrated in FIG. 4, the belonging user may be managed by the user ID or managed by the user name, for example.

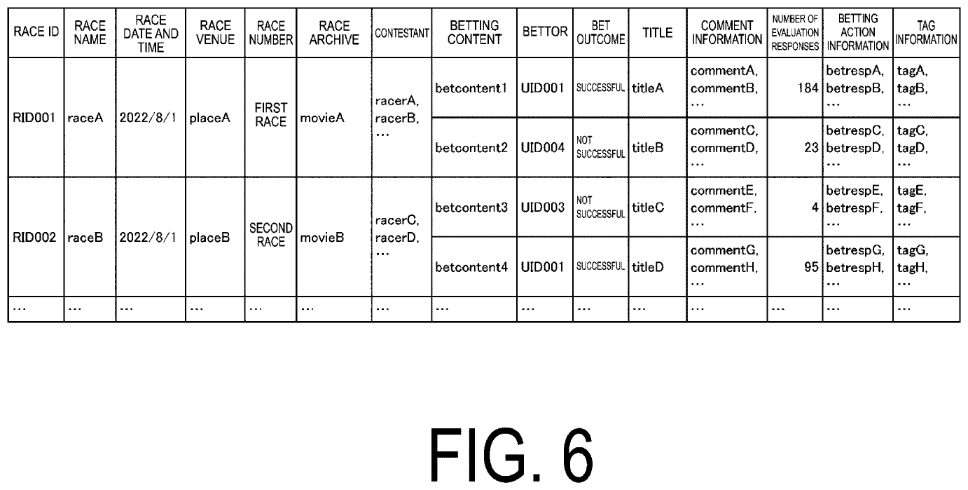

FIG. 6 is a diagram illustrating an example of data managed as the race history management DB100c. Data managed as the race history management DB 100c is managed for each race. That is, other information is managed in association with one race. More specifically, as illustrated in FIG. 6, the race history management DB100c manages, as information about the race, the race ID, race name, race date and time, race venue, race number, race archive, contestant, betting content, bettor, bet outcome, title, comment information, number of evaluation responses, betting action information, and tag information, for example.

The race ID is an identifier for uniquely identifying the race in the server 10. The race name is a name determined by the organizer or operator of the race, for example. The race date and time is information about the date and time of the race. The race venue is information about the venue of the race such as the name of the venue. The race number is the number of the race held at the race venue on the race date. The race archive is a video recording of the race, for example. The contestant is information about a contestant of the race such as the name of contestant.

The betting content is the content of the bet placed by the user for the race. In the case where a plurality of users has placed bets on a race, the subsequent items (i.e., the bettor, bet outcome, title, comment information, number of evaluation responses, betting action information, and tag information) are further managed in association with the betting content. The bettor is the user who has placed a bet. The bettor may be managed by the user ID or user name. The bet outcome is information representing whether the bet has been successful or not, such as win or lose. The title is a title of the information about the race. The title can be created by the bettor, for example. The comment information is information about a comment the posted in response to bet information. The comment information includes information such as the content of a comment, the user who has posted the comment, and the date and time of the comment, for example. The number of evaluation responses is the number of evaluation responses as responses to bet information. The number of evaluation responses may be aggregated by evaluation content (e.g., high evaluation and low evaluation), for example. The betting action information is information about a betting action performed in response to bet information. The betting action information includes the number of bandwagon bets, for example. The tag information is information about words tagged in relation to the race. The tag information may be created by the bettor, for example.

The bet screen generation section 101 generates a bet screen for receiving a bet from the user. For example, the bet screen generation section 101 generates bet screen data to be displayed on the display of the terminal apparatus 20 in response to an access from a Web browser of the terminal apparatus 20 or an access from a dedicated application installed in the terminal apparatus 20. The generated bet screen data is provided by the provision section 105 to the terminal apparatus 20 via the communication IF 13.

The terminal apparatus 20 displays the bet screen on the display serving as the output device 15 on the basis of the provided bet screen data. The user can place a bet from the bet screen. More specifically, the user selects the race as the betting target on the bet screen, and inputs the betting target, betting method, bet amount, and the like. The terminal apparatus 20 generates bet information on the basis of the input information. The terminal apparatus 20 transmits the generated bet information to the server 10.

The bet information acquiring section 102 acquires the bet information transmitted from the terminal apparatus 20. In this manner, a bet is received from the user.

The posting information generation section 103 generates posting information to be posted on the terminal apparatus 20. The posting information generation section 103 generates posting information in accordance with the bet information when the bet information acquiring section 102 acquires bet information, for example. The posting information includes the posting screen data. The posting screen is a display screen that displays the content of the posting information. The posting screen includes bet information, and a response input section for inputting a response to the bet information, for example.

The generated posting information is provided to the terminal apparatus 20 via the communication IF 13 by the provision section 105. For example, the posting information is provided to the terminal apparatus 20 in response to an access from a Web browser of the terminal apparatus 20 or an access from a dedicated application installed in the terminal apparatus 20. The posting information may be provided to the terminal apparatus 20 when it is generated or updated regardless of the access from the terminal apparatus 20. At this time, the posting information may be provided to only a specific terminal apparatus 20. For example, the posting information may be provided to only the terminal apparatus 20 used by a user in a predetermined relationship with the user who has placed a bet corresponding to the bet information. In the present embodiment, the following assumes that the predetermined relationship is a relationship belonging to the same group.

On the basis of the provided posting information, the terminal apparatus 20 displays a posting screen on the display serving as the output device 15. The user can input a response from the posting screen. The terminal apparatus 20 transmits to the server 10 response information corresponding to the input response.

The response acquiring section 104 acquires the response information transmitted from the terminal apparatus 20. In this manner, response information for bet information is received.

The posting information generation section 103 may generate posting information corresponding to the response when the response acquiring section 104 acquires response information. For example, the posting information generation section 103 generates the posting information corresponding to the response by updating the posting information. More specifically, the posting information generation section 103 updates the posting information when the response acquiring section 104 adds the response information to the posting information. The posting information corresponding to the response (i.e., the updated posting information) is provided to the terminal apparatus 20 via the communication IF 13 by the provision section 105. For example, when the posting information is provided to the terminal apparatus 20 of the user who has placed a bet corresponding to the bet information and the posting screen is displayed on the display of the terminal apparatus 20, the user can view the responses of other users to the user's bet.

The provision section 105 provides bet screen data to the user. In addition, the provision section 105 provides posting information to the user.

The management section 106 manages various data acquired from the terminal apparatus 20. For example, when the bet information acquiring section 102 acquires bet information, the management section 106 stores the bet information in the storage section 100 in association with the race. More specifically, the management section 106 stores the information included in bet information in the race history management DB100c in association with the race ID of the race corresponding to the bet information. In addition, when the response acquiring section 104 acquires response information, the management section 106 stores the response information in the storage section 100 in association with the race. More specifically, the management section 106 stores the response information in the race history management DB100c in association with the race ID of the race corresponding to the bet information to which the response has been made. In this manner, the management section 106 stores the bet information and response information in the storage section 100 in association with the race. By storing information in association with the race, information associated with each race is accumulated.

The management section 106 processes the bet placed by the user on the basis of the bet information acquired by the bet information acquiring section 102. The management section 106 may transmit the bet information to another information processing device capable of communicating with the server 10 to request the other information processing device to execute a betting process.

Further, the management section 106 increases or reduces, for a user, a predetermined value owned by the user on the basis of a predetermined value of the bet in accordance with whether the betting content of the bet placed by the user has been successful. For example, when the betting content is successful, the management section 106 grants the predetermined value to the user who has been successful in betting by increasing the balance of the user management BD illustrated in FIG. 4 in accordance with the amount of the predetermined value to be paid out. When the betting content is not successful, the management section 106 reduces the balance of the user management BD illustrated in FIG. 4 in accordance with the bet amount.

In addition, the management section 106 manages groups. For example, the management section 106 performs a process of creating groups, a process of adding another user to a group, a process of deleting a user leaving a group from the group, and the like. A group may be created when other users agree to join the group for the user who convenes the group.

### Processing Procedure

### Before Start of Race

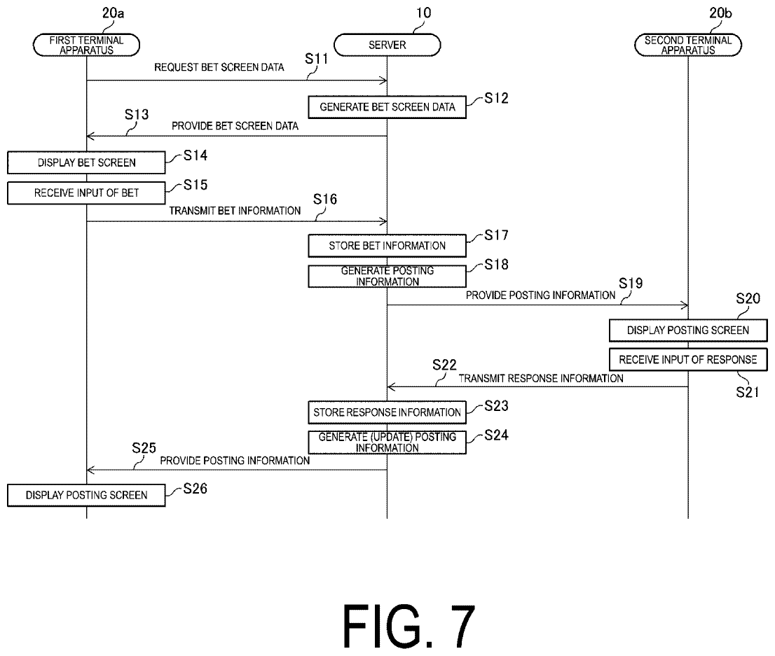

Next, an example of a processing procedure executed by the information processing system 1 is described. FIG. 7 is a sequence diagram illustrating an example of a processing procedure executed by the information processing system 1, and is a sequence diagram illustrating an example of a processing procedure of a case where the user places a bet before the start of a race. Here, the user using the first terminal apparatus 20a is referred to as first user, and the user using the second terminal apparatus 20b is referred to as second user. The first user and the second user have a predetermined relationship. Specifically, in the present embodiment, the first user and the second user belong to the same group. In addition, the following description assumes that when the user places a bet, the server 10 provides posting information generated based on bet information corresponding to the bet to another user belonging to the same group as the user.

When the first user performs an input operation to display a bet screen using the first terminal apparatus 20a, the first terminal apparatus 20a requests bet screen data by accessing the server 10 from the Web browser or dedicated application on the basis of the input operation (step S11). Specifically, the first terminal apparatus 20a transmits a data requesting signal to the server 10. At this time, the first user can request a bet screen related to a specific race. For example, the first user narrows down the race as the betting target by the race name, race date and time, race venue, race number, contestants. The first terminal apparatus 20a can request the bet screen related to the race as the betting target extracted by the narrowing down.

The server 10 receives the data requesting signal from the first terminal apparatus 20a. When receiving a request of bet screen data, the server 10 generates bet screen data by the bet screen generation section 101 (step S12). When the race as the betting target has been narrowed down through input operation of the first user, bet screen data on a race matching the condition is generated.

The server 10 provides the bet screen data generated by the bet screen generation section 101 to the first terminal apparatus 20a via the communication IF 13 (step S13). Specifically, the server 10 transmits the bet screen data to the first terminal apparatus 20a.

The first terminal apparatus 20a receives the bet screen data from the server 10. The first terminal apparatus 20a displays the bet screen on the display on the basis of the bet screen data received from the server 10 (step S14).

The first terminal apparatus 20a receives on the bet screen an input of a bet from the first user (step S15).

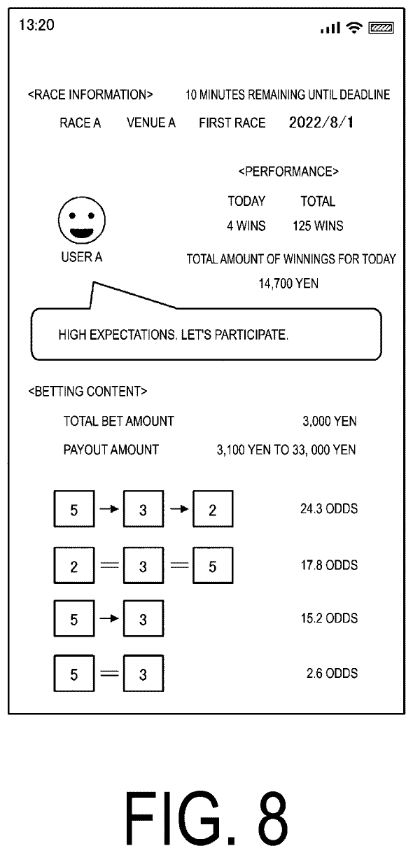

FIG. 8 is a diagram illustrating an example of a bet screen displayed on the terminal apparatus 20, e.g., an example of a screen displayed on the display of the first terminal apparatus 20a at step S14 and step S15. In the example illustrated in FIG. 8, a race as the betting target has been specified, and a bet screen corresponding to the race as the betting target is displayed.

On the bet screen, information about a race itself of the specified betting target is displayed, for example. In the example illustrated in FIG. 8, the race name “race A”, the race venue “venue A”, the race number “first race”, and the race date and time “2022 Aug. 1” are displayed as the information about the race itself of the betting target. On the bet screen, information representing the deadline for betting may be displayed. In the example illustrated in FIG. 8, the information representing the deadline for betting is displayed with the statement “10 minutes to deadline” indicating that there are 10 minutes remaining until the deadline.

The bet screen displays information about the first user who places a bet, for example. In the example illustrated in FIG. 8, as the information about the first user, the user name “user A” of the first user, the icon of the first user, and the performance of the first user are displayed. The icon of the first user can be freely set or changed by the first user, for example. In the example illustrated in FIG. 8, as the performance of the first user, the number of wins for today and the total number of wins (overall) are displayed. The number of wins corresponds to the number of successful bets. In addition, in the example illustrated in FIG. 8, the total amount for today's successful bets is displayed as the performance of the first user.

The bet screen further displays the betting content based on the input of the first user. In the example illustrated in FIG. 8, as the betting content, the bet amount “3,000 Yen”, the betting target and the betting method are displayed. In the example illustrated in FIG. 8, the betting targets are indicated by the numbers corresponding to the contestants of the race, and the betting methods are indicated by symbols. For example, betting methods such as the exacta and trifecta, where the order of finishing is predicted, are indicated by arrows, while betting methods such as the quinella and trio, where the order does not matter, are indicated by the symbol “=”. As illustrated in FIG. 8, as the betting content, odds and payout amount may be displayed. The payout amount is the amount that will be paid out if the betting content is successful. For example, as illustrated in FIG. 8, it is displayed as a range of possible amounts that may be paid out in the case of a successful bet. In addition, as the betting content, a comment of the first user who has placed a bet may be displayed. The comment may be freely input by the user. In the example illustrated in FIG. 8, a comment “High expectations. Let's participate” is displayed. In addition, the betting content may include tag information added by the user.

With reference to FIG. 7 again, when the first user has determined the betting content and completed the input to the first terminal apparatus 20a, the first user performs an input operation for executing the betting process. On the basis of the input operation, the first terminal apparatus 20a transmits to the server 10 the bet information related to the bet received at step S15 (step S16). Specifically, the first terminal apparatus 20a transmits bet information data to the server 10.

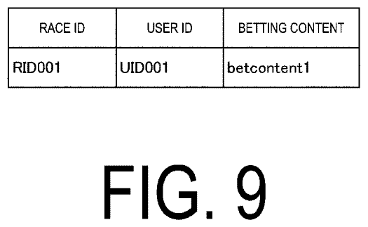

FIG. 9 is a diagram illustrating an example of bet information data transmitted from the terminal apparatus 20, and is a diagram illustrating an example of bet information data transmitted from the first terminal apparatus 20a to the server 10 at step S16 in the present embodiment. As illustrated in FIG. 9, bet information data includes the race ID of the race bet by the first user as the betting target, the user ID of the first user, and the betting content of the first user. The betting content is the bet content input at step S15, and includes the betting target, betting method, bet amount and odds, for example. The betting content may further include the comment of the first user input at step S15.

With reference to FIG. 7 again, the server 10 receives bet information data from the first terminal apparatus 20a. When receiving bet information at the bet information acquiring section 102 from the first terminal apparatus 20a, the server 10 stores the received bet information (step S17). For example, the management section 106 stores the bet information acquired by the bet information acquiring section 102 in the storage section 100 in association with the race. More specifically, the management section 106 stores the betting content included in the bet information in the race history management DB100c of the storage section 100 in association with the race ID included in the bet information.

For example, it is assumed that the server 10 has received the bet information data illustrated in FIG. 9 at step S16. In this case, the server 10 stores the user ID “UID001” and the betting content “bitcontent1” in association with the race ID “RID001” in the data stored in the race history management BD100c illustrated in FIG. 6 on the basis of the race ID “RID001” included in the bet information data. More specifically, the acquired user ID “UID001” is stored in the column of “bettor” of FIG. 6, and the acquired betting content “bitcontent1” is stored in the column of “betting content”. More specifically, the betting content “bitcontent1” includes the betting target, betting method, and bet amount, and the like. The betting target is indicated by the contestant or the reference numeral (number) indicating contestant. The betting method is win, show, exacta, trifecta, trio, or the like. The bet amount is the size of the predetermined value to be bet for the betting target. In this manner, the betting content of the bet placed by the first user is added to the race history management DB100c.

In addition, the server 10 generates posting information corresponding to the bet information (step S18). More specifically, the posting information generation section 103 generates posting information including the posting screen data. The posting information includes the bet information content acquired from the first terminal apparatus 20a.

The server 10 provides the posting information generated by the posting information generation section 103 to the other user via the communication IF 13. The server 10 may provide the posting information to a plurality of users, for example. The server 10 may provide the posting information to only a specific user. For example, the server 10 may provide the posting information to only the user who has a predetermined relationship with (here, the user who belongs to the same group as) the first user who has placed a bet with reference to the group management DB100b. It is assumed here that the server 10 provides the posting information to the second user on behalf of users belonging to the same group. Specifically, in this example, the server 10 provides the posting information to the second terminal apparatus 20b used by the second user (step S19). Therefore, the server 10 transmits posting information data to the second terminal apparatus 20b.

The second terminal apparatus 20b receives the posting information data from the server 10. The second terminal apparatus 20b displays the posting screen on the display on the basis of the posting information received from the server 10 (step S20).

The second terminal apparatus 20b receives an input response from the second user on the posting screen (step S21).

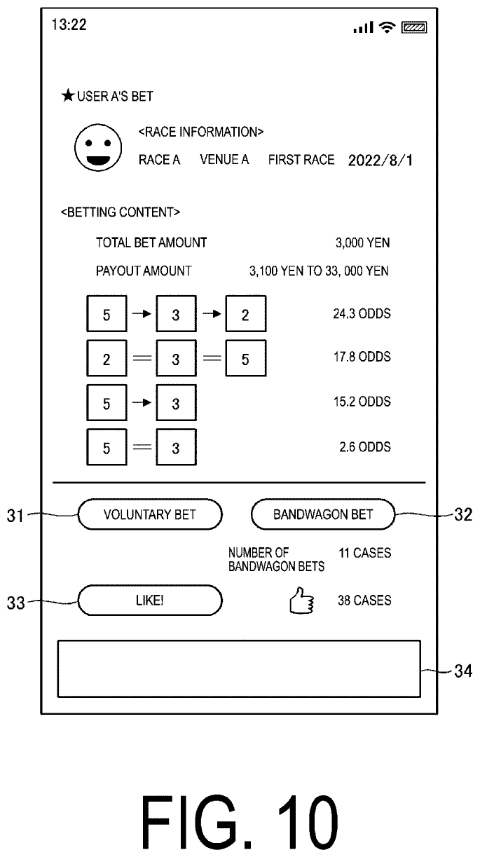

FIG. 10 is a diagram illustrating an example of a bet screen displayed on the terminal apparatus 20, and illustrating an example of a screen that is displayed on the display of the second terminal apparatus 20b at step S20 and step S21. On the posting screen, the bet information, and a response input section for inputting a response to the bet information are displayed.

The bet information is bet information corresponding to the bet placed by the first user. For example, in the example illustrated in FIG. 10, the icon of the first user who has placed a bet, information about a race itself bet by the first user, and a betting content are displayed. The information about a race itself and the betting content are the same as those described with reference to FIG. 8, for example. Although not illustrated in FIG. 10, the comment input by the first user may be further displayed on the posting screen.

The response input section is a section for the second user to input a response to bet information. In the example illustrated in FIG. 10, the response input section is provided with a voluntary bet button 31, a bandwagon bet button 32, a like button 33, and a comment entry field 34.

The voluntary bet button 31 is an input button for the second user to place a bet of the betting content determined by their own for the same race as the race bet by the first user. When the second user wishes to place a bet of the betting content selected by their own, the second user performs an input operation of selecting the voluntary bet button 31. When detecting an input operation of selecting the voluntary bet button 31, the second terminal apparatus 20b displays an input screen for receiving the bet placed by the second user to receive the bet.

The bandwagon bet button 32 is an input button for the second user to place a bet for the same betting target as the first user by the same betting method as the first user. When the second user wishes to place a bet for the same betting target as the first user by the same betting method as the first user, the second user performs an input operation of selecting the bandwagon bet button 32. When detecting an input operation of selecting the bandwagon bet button 32, the second terminal apparatus 20b receives a bandwagon bet placed by the second user. In the bandwagon bet, at least betting target and betting method are the same as those of the first user. In the bandwagon bet, the second user may select the bet amount by their own. In this case, the second terminal apparatus 20b receives the bet amount input by the second user.

Note that, the number of users who has placed a bandwagon bet for the bet information of the first user may be displayed on the posting screen as illustrated in FIG. 10. The second user can determine whether to place a bandwagon bet with reference to the number of users who has placed a bandwagon bet.

The like button 33 is an input button for making an evaluation response to the bet information of the first user. The second user performs an input operation of selecting the like button 33 when the second user views the bet information of the first user or feels that the bet information of the first user is good, or the like, for example. The posting screen may display the number of users who have selected the like button 33 as illustrated in FIG. 10.

The comment entry field 34 is an entry field for the second user to input a textual comment regarding the bet information of the first user. The comment entry field 34 may receive an input of a comment to be directly transmitted to the first user, or an input of a comment to be public to a plurality of users (e.g., users belonging to the same group).

When the second user performs an input operation of selecting the voluntary bet button 31, the bandwagon bet button 32 or the like button 33, or when the second user inputs a comment in the comment entry field 34, the second terminal apparatus 20b receives the operation as a response from the second user (step S21).

With reference to FIG. 7 again, when the second user inputs a response, the second terminal apparatus 20b transmits response information to the server 10 on the basis of the response received as input at step S21 (step S22). Specifically, the second terminal apparatus 20b transmits response information data to the server 10.

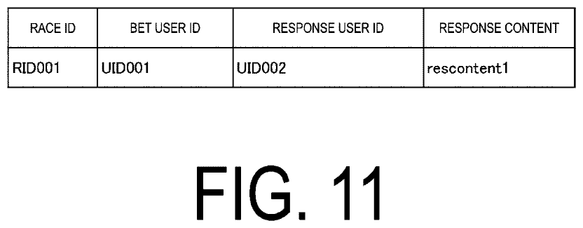

FIG. 11 is a diagram illustrating an example of response information data transmitted from the terminal apparatus 20, and is a diagram illustrating an example of response information data transmitted from the second terminal apparatus 20b to the server 10 at step S22 in the present embodiment. As illustrated in FIG. 11, the response information data includes the race ID of the race bet by the first user as the betting target, a bet user ID, a response user ID, and a response content. The bet user ID is the user ID of the user who has placed an original bet (which is not the voluntary bet or the bandwagon bet, but is a bet placed from the bet screen displayed at step S14), and is, in this example, the user ID of the first user. The response user ID is the user ID of the user who has made a response, and is, in this example the user ID of the second user. The response content is appropriate information in accordance with the response content input by the second user. For example, the response content includes a betting content of a voluntary bet, a betting content of a bandwagon bet, an evaluation response or a comment.

With reference to FIG. 7 again, the server 10 receives response information data from the second terminal apparatus 20b. When receiving response information from the second terminal apparatus 20b at the response acquiring section 104, the server 10 stores the received response information (step S23). For example, the management section 106 stores in the storage section 100 the response information acquired by the response acquiring section 104 in association with the race. More specifically, the management section 106 stores in the race history management DB100c of the storage section 100 the response content included in the response information in association with the race ID included in the response information. For example, when the response content includes a betting action of a voluntary bet or a betting action of a bandwagon bet, the management section 106 stores in the betting action information illustrated in FIG. 6 the content of a betting action of a voluntary bet or a betting action of a bandwagon bet. When the response content includes an evaluation response, the management section 106 increments the number of evaluation responses illustrated in FIG. 6 by one. When the response content includes a comment, the management section 106 stores the comment information illustrated in FIG. 6 in the comment content.

For example, it is assumed that the server 10 has received the response information data illustrated in FIG. 11 at step S22. In this case, the server 10 stores the response user ID “UID002” and the response content “rescontent1” in association with the race ID “RID001” and the bettor “UID001” in the data stored in the race history management BD100c illustrated in FIG. 6 on the basis of the race ID “RID001” and the bet user ID “UID001” included in the response information data. The response content “rescontent1” is a response content of the user with the response user ID “UID002”, and includes, for example, any of comment information, betting action information and evaluation response. In accordance with the response content, the server 10 stores the information in the column “comment information” or “betting action information”in FIG. 6, or increments the “number of evaluation responses”by one.

For example, in the case where the response content “rescontent1” includes comment information “comment A”, the server 10 stores “comment A” in the column “comment information” in association with the race ID “RID001” and the bettor “UID001”. The comment information “comment A” is a text as a comment input by the user with the response user ID “UID002”, for example. At this time, the server 10 stores the comment information “comment A”in association with the response user ID “UID002” although omitted in FIG. 6.

For example, in the case where the response content “rescontent1” includes betting action information “bitrespA”, the server 10 stores “bitrespA” in the column “betting action information” in association with the race ID “RID001” and the bettor “UID001”. The betting action information “bitrespA” is the betting content of the user with the response user ID “UID002”, which is betting content of the voluntary bet or the bandwagon bet, for example. The betting content includes the betting target, betting method, bet amount, and the like. At this time, the server 10 stores the betting action information “bitrespA” in association with the response user ID “UID002” although omitted in FIG. 6.

For example, in the case where the response content “rescontent1” includes an evaluation response, the server 10 increments the “number of evaluation responses” associated with the race ID “RID001” and the bettor “UID001” by one. The evaluation response is “like”, for example. In the case where the “number of evaluation responses” before the increment is “183”, the server increments the “number of evaluation responses” by one to “184”. At this time, although omitted in FIG. 6, the server 10 may store the response user ID “UID002” as the user ID who has made the evaluation response in association with the race ID “RID001” and the bettor “UID001”.

In this manner, the response information of the second user is added in the race history management DB100c.

In addition, the server 10 generates posting information corresponding to the response (step S24). More specifically, the posting information generation section 103 generates posting information including response information. At this time, the posting information generation section 103 generates posting information by updating the posting information by adding the response information to the posting information generated at step S18, for example. The posting information includes the content of the response information acquired from the second terminal apparatus 20b. When the posting information generation section 103 acquires response information from the terminal apparatus 20 used by another user other than the second user, the posting information generation section 103 may update the race history management DB100c and the posting information by executing step S23 and step S24 each the time response information is acquired. In this manner, posting information corresponding to the response is generated.

The server 10 provides the posting information generated (updated) by the posting information generation section 103 to the other user via the communication IF 13. The server 10 provides the posting information to the first user, for example. Specifically, in this example, the server 10 provides the posting information corresponding to the response to the first terminal apparatus 20a used by the first user (step S25). Accordingly, the server 10 transmits the posting information data to the first terminal apparatus 20a.

The first terminal apparatus 20a receives the posting information data from the server 10. The first terminal apparatus 20a displays the posting screen on the display on the basis of the posting information received from the server 10 (step S26). In this manner, the first user can confirm the response from other users (in this case, the second user).

### After Race

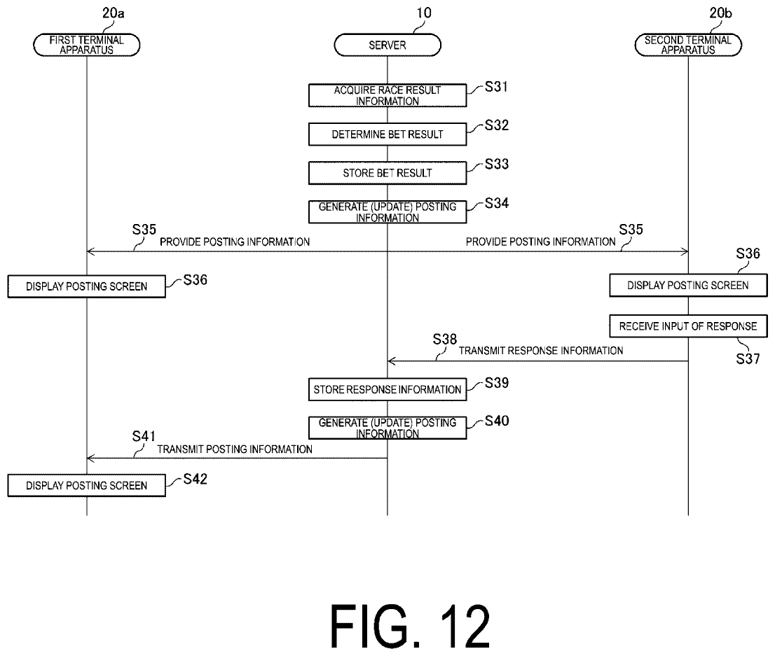

Next, another example of a processing procedure executed by the information processing system 1 is described. FIG. 12 is a sequence diagram illustrating another example of a processing procedure executed by the information processing system 1, and is a sequence diagram illustrating an example of a processing procedure after a race has been conducted.

After a race bet by the user (in this example, the first user) has been conducted, the server 10 acquires information about results of the race (hereinafter referred to also as “race result information”) (step S31). The server 10 acquires the race result information from a server managed by the organizer or operator of the race, for example. The race result information includes the race ID, race results, and race archive. The race results show the finishing positions of the race contestants.

The server 10 determines the bet result on the basis of acquired race result information (step S32). For example, the management section 106 determines whether the bet placed by the first user is successful on the basis of the race result information. The bet results of other users other than the first user are also determined. Through the determination, the server 10 generates the bet outcome.

The server 10 stores the bet outcome on the basis of the bet outcome determined at step S32 (step S33). For example, the management section 106 stores the bet outcome determined at step S32 in the storage section 100 in association with the race and the user who placed the bet. More specifically, the management section 106 stores the determined bet outcome in the race history management DB100c of the storage section 100 in association with the race ID included in the race result information, and the user ID of the user who placed the bet on the race. In this manner, the bet information of the first user is added to the race history management DB100c. That is, “successful” or “not successful” are stored as illustrated in “bet outcome” in FIG. 6. At this time, the management section 106 may store the race archive included in the race result information in association with the race in the storage section 100, for example. In this manner, the information about the race archive and the bet outcome of the race are accumulated.

Specifically, for example, it is assumed that in the race “RID001” illustrated in FIG. 6, the betting content “bitcontent1” of a bettor “UID001” is successful and the betting content “bitcontent2” of a bettor “UID004” is not successful. Each of the betting contents “bitcontent1” and “bitcontent2” includes the betting target, betting method, bet amount, and the like. Here, regarding the betting content “bitcontent1” and “bitcontent2”, which differ in the betting target, the betting content “bitcontent1” is successful, and the betting content “bitcontent2” of the bettor “UID004” is not successful, for example. In this case, as illustrated in FIG. 6, the server 10 stores information representing “successful” in the column “bet outcome” in association with the race ID “RID001” and the bettor “UID001”. In addition, as illustrated in FIG. 6, the server 10 stores information representing “not successful” in the column “bet outcome” in association with the race ID “RID001” and the bettor “UID004”.

In addition, it is assumed that the server 10 has acquired at step S31 race result information including the race ID “RID001” and the race archive “movie A”. The race archive “movie A” is a video recording of the race with the race ID “RID001”. In this case, on the basis of the race ID “RID001” included in the race result information, the server 10 stores the race archive “movie A” in association with the race ID “RID001” in the data stored in the race history management BD100c illustrated in FIG. 6.

The server 10 generates posting information corresponding to the bet outcome (step S34). For example, the posting information generation section 103 generates the posting information including the bet outcome. At this time, the posting information generation section 103 generates the posting information by updating the posting information by adding the bet outcome to previously generated latest posting information related to the race. The posting information generation section 103 may generate the posting information including the bet outcome only when the bet placed by the user is successful.

Here, the posting information generation section 103 may generate different posting information depending on the user. For example, the posting information generation section 103 may generate different posting information for the user who has placed a bet (in this example, the first user) and the user who has not placed a bet (in this example, the second user). The posting information generation section 103 generates the posting information including the posting screen data representing whether the bet has been successful for the first user who has placed a bet, for example. The posting information generation section 103 generates the posting information including the posting screen data representing a success when the bet placed by another user belonging to the same group is successful for the second user who has not placed a bet, for example.

The server 10 provides the posting information generated (updated) by the posting information generation section 103 to each user via the communication IF 13. That is, the server 10 transmits to the terminal apparatus the transmitted posting information data. Here, the server 10 provides the posting information to the first user and the second user. Specifically, in this example, the server 10 provides the posting information to the first terminal apparatus 20a used by the first user and the terminal apparatus 20b used by the second user (step S35). In the case where the server 10 generates different posting information depending on the users at step S34, the server 10 provides different posting information to the first user and the second user.

The first terminal apparatus 20a and the second terminal apparatus 20b display the posting screen on the display on the basis of the posting information received from the server 10 (step S36). In this manner, posting screens including bet outcomes are displayed on the displays of the first terminal apparatus 20a and the second terminal apparatus 20b.

The first user and the second user can make a response on the posting screen. The following describes a case where the second user makes a response is described. The second terminal apparatus 20b receives an input response from the second user on the posting screen (step S37).

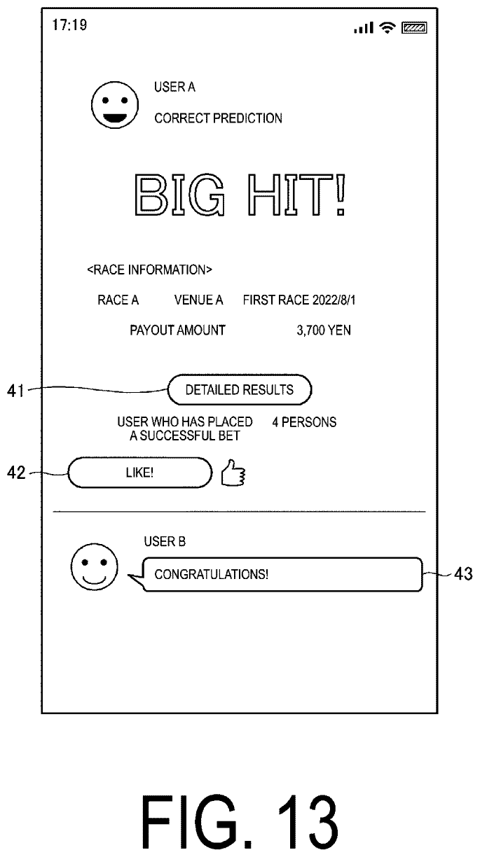

FIG. 13 is a diagram illustrating a posting screen displayed on the terminal apparatus 20, which is an example of a screen displayed on the display of the second terminal apparatus 20b at step S36 and step S37. Bet information about the user who has been successful in betting, and the response input section for inputting a response to the bet information are displayed on the posting screen, for example.

For example, as illustrated in FIG. 13, the icon of the first user who has been successful in betting and the user name of the first user are displayed on the posting screen. In addition, letters “BIG HIT”indicating a success are displayed as the bet outcome on the posting screen. Further, the information about a race itself and the betting content are displayed as the bet information.

For example, as illustrated in FIG. 13, a detailed result display button 41 is displayed on the posting screen. When the second user performs an operation of selecting the detailed result display button 41, detailed information related to the successful race is displayed. The detailed information includes not only information about a race itself and betting content, but also the race archive, response information for bet information, and the like, for example.

The response input section is a section for the second user to input a response to the bet outcome. In the example illustrated in FIG. 13, the response input section is provided with a like button 42 and a comment entry field 43.

The like button 42 is an input button for making an evaluation response to the bet outcome. When the second user views the bet outcome or feels that the bet outcome is good, the second user performs an input operation of selecting the like button 42, for example.

The comment entry field 43 is an entry field for the second user to input a textual comment for the bet outcome. The comment entry field 43 may receive an input of a comment to be directly transmitted to the first user, or an input of a comment to be public to a plurality of users (e.g., users belonging to the same group). In addition, the comment entry field 43 not only allows the second user to input comments, but also displays comments input by other users. That is, the second user can interact with other users through comments in the comment entry field 43.

Note that, as illustrated in FIG. 13, on the posting screen after a race has been conducted, unlike on the posting screen before the start of the race illustrated in FIG. 11, the voluntary bet button 31 and the bandwagon bet button 32 for placing a bet as a response are not displayed. The reason for this is that the race has already been completed and a bet cannot be placed.

When the second user performs an input operation of selecting the like button 42 or inputs a comment in the comment entry field 43, the second terminal apparatus 20b receives these operations as a response from the second user (step S37).

With reference to FIG. 12 again, when the second user inputs a response, the second terminal apparatus 20b transmits response information to the server 10 on the basis of the response received at step S37 (step S38). Specifically, the second terminal apparatus 20b transmits response information data to the server 10. The response information data may be the same as that described with reference to FIG. 11, and therefore the description thereof is omitted here.

When receiving response information from the second terminal apparatus 20b at the response acquiring section 104, the server 10 stores the received response information (step S39). In this manner, the response information is accumulated in association with the race. In addition, the server 10 generates posting information corresponding to the response (step S40). The server 10 provides the posting information generated (updated) by the posting information generation section 103 to the other user via the communication IF 13. In this example, the server 10 provides the posting information to the first terminal apparatus 20a used by the first user (step S41). Specifically, the server 10 transmits the updated posting information data to the first terminal apparatus 20a. The first terminal apparatus 20a displays the posting screen on the display on the basis of the posting information received from the server 10 (step S42). In this manner, the first user can confirm the response from other users (in this case, the second user). Note that, the details of step S39 step S42 may be the same as those of step S23 step S26 described above with reference to FIG. 7, and therefore the description thereof is omitted here.

Note that, for example, it is assumed that when the terminal apparatus 20 displays the bet information placed by the user related to a certain race (for example, when the posting screen illustrated in FIG. 10 is displayed), the server 10 stores a bet result based on the race result information related to another race (step S33). In this case, the server 10 may display simple result information below the posting screen illustrated in FIG. 10, for example. The simple result information is composed of the name of the user who placed the bet, and the bet outcome (e.g., an indication “BIG HIT!”), for example. When the user who has recognized the simple result wishes to view the details of the information result information, the user performs an input operation of selecting the simple result information, for example. On the basis of the input operation, the terminal apparatus 20 displays a posting screen illustrated in FIG. 13 as specific result information, for example. Further, the terminal apparatus 20 may appropriately display the simple result information when another user (e.g., another user belonging to the same group) has been successful in betting.

In this manner, by storing response information in association with the race in a process before or after a race, the server 10 can record the communications through the responses with other users related to the race. In this manner, the server 10 can easily manage the recording of the communications with other users related to the race bet by the first user.

### Viewing of History Information

The user can view information about past races (hereinafter referred to also as “race history information”) stored in the server 10. The race history information is information about the races that have been conducted, which is included in the race history management DB. In addition, in the following description, the user is the first user for easy understanding, but the user herein may be the first user and/or the second user. Therefore, the following description also applies to the second user.

For example, the first user performs an input operation of requesting a list of the race history information in the Web browser provided in the first terminal apparatus 20a or the dedicated application installed in the first terminal apparatus 20a. On the basis of the input operation, the first terminal apparatus 20a requests screen data representing the list of the race history information from the server 10. At this time, the first terminal apparatus 20a transmits the user ID of the first user to the server 10. The management section 106 of the server 10 generates screen data for displaying on the first terminal apparatus 20a a list of race history information related to the first user from among the races stored in the storage section 100. More specifically, the management section 106 extracts information about the race related to the user ID of the first user in the information stored in the race history management DB100c of the storage section 100, and generates screen data to be displayed on the first terminal apparatus 20a on the basis of the extracted information. The server 10 extracts information about the race where the user ID of the first user is stored as “bettor” in FIG. 6, for example. It should be noted that, the server 10 may extract the race bet or responded by the first user as information about the race related to the user ID of the first user. That is, the server 10 may extract not only the race where the user ID of the first user is stored as “bettor” in FIG. 6, but also the race responded by the first user. The server 10 provides the first user with the generated screen data by transmitting it to the first terminal apparatus 20a via the communication IF 13. The first terminal apparatus 20a displays the list of the race history information on the display on the basis of the received screen data.

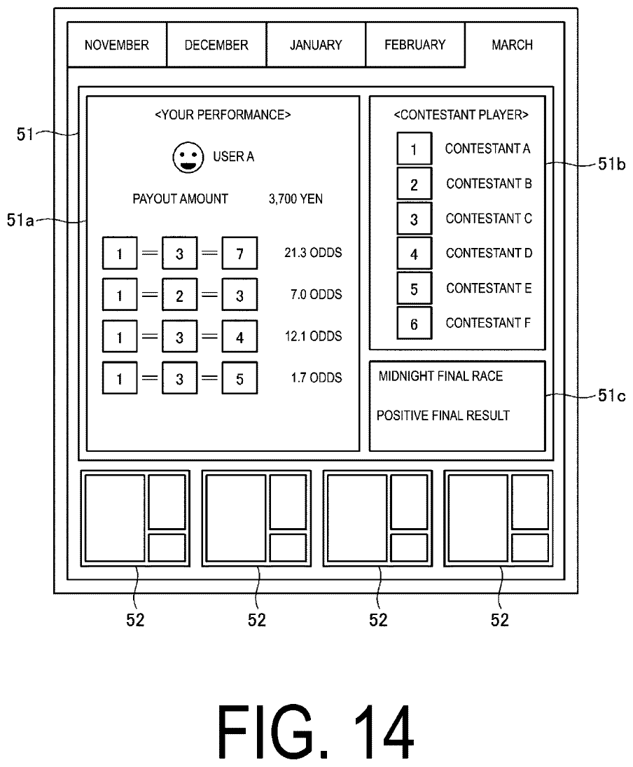

FIG. 14 is a diagram illustrating a first example of a list of the race history information. In the first example, the list of the race history information is displayed by month. In the example illustrated in FIG. 14, tabs from November to March are displayed, and when a tab is selected, the list of the race history information for the month desired by the first user can be viewed. In the example illustrated in FIG. 14, the tab of March is selected, and the list of the race history information for March is displayed.

In the list of the race history information of the first example, information about one race (hereinafter referred to also as “overview information”) among the races conducted in the month concerned is displayed in a larger size, and information (overview information) about the other races conducted in the month concerned is displayed in a smaller size on the lower side of the information about the one race. More specifically, as illustrated in FIG. 14, the overview information 51 is displayed in a larger size, and a plurality of overview information 52 is displayed below the overview information 51 in a size smaller than the overview information 51.

The overview information 51 includes performance information 51a, contestant information 51b, and comment information 51c as illustrated in FIG. 14, for example. The performance information 51a is information representing the performance of the first user in a race represented by the overview information 51 and includes the bet outcome, payout amount, betting content, and the like for example. The contestant information 51b is information representing a contestant in the race represented by the overview information 51 and includes the contestant name, relevant information about each contestant, and the like, for example. The relevant information about a contestant may include the profile and past results of the contestant and the like, for example. The comment information 51c is information representing a comment input by the first user about the race represented by the overview information 51.

The overview information 52 indicates information about items similar to those of the overview information 51, for example. Specifically, the items indicated in the overview information 52 may be the same as those of the overview information 51, except for the difference in display size.

When receiving an input operation for selecting any of the overview information 52 displayed in a smaller size is received from the first user, the first terminal apparatus 20a switches the display positions of the selected overview information 52 and the overview information 51 displayed in a larger size. That is, the first user can display the desired overview information in a larger size by selecting it.

Alternatively, when receiving from the first user an input operation for selecting any of the overview information 51 displayed in a larger size and the overview information 52 displayed in a smaller size, the first terminal apparatus 20a may operate to display detailed information about selected race. In this case, the first terminal apparatus 20a requests detailed information from the server 10, and the server 10 transmits detailed information to the first terminal apparatus 20a in response to the request, for example. Details of the display content of the detailed information are described later.

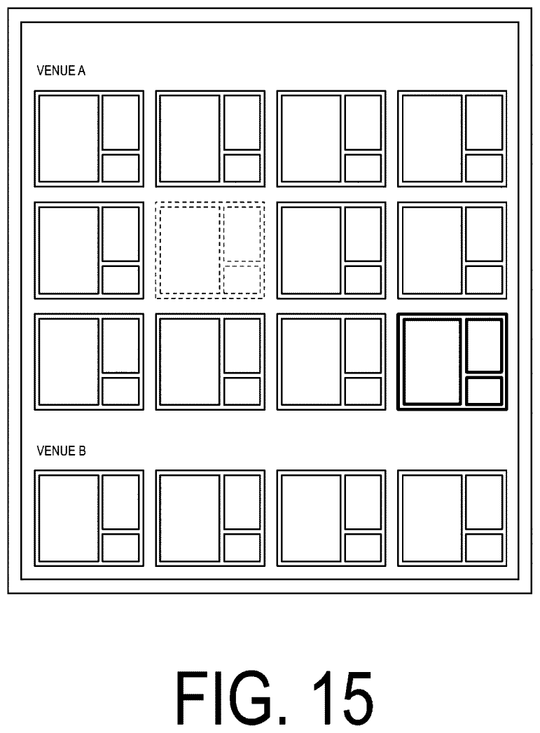

FIG. 15 is a diagram illustrating a second example of a list of the race history information. In the second example, the list of the race history information is displayed by the race venue. For example, in the example illustrated in FIG. 15, overview information about race history related to the race conducted at the venue A and the race conducted at the venue B are displayed. The display content of the overview information may be the same as the overview information 52 described with reference to FIG. 14, and therefore the description thereof is omitted here.

When receiving from the first user an input operation for selecting any of the overview information indicated in the list of the race history information of FIG. 15, the first terminal apparatus 20a operates to display the detailed information about the selected race. In this case, the first terminal apparatus 20a requests detailed information from the server 10, and the server 10 transmits detailed information to the first terminal apparatus 20a in response to the request, for example.

In addition, the first terminal apparatus 20a may switch the list of the race history information between the display form illustrated in FIG. 14 and the display form illustrated in FIG. 15 on the basis of the input operation by the first user. That is, the first user can switch the display form illustrated in FIG. 14 and the display form illustrated in FIG. 15 by a specific input operation.

In the list of the race history information illustrated in FIGS. 14 and 15, specific overview information can be displayed in a form different form other overview information. For example, the management section 106 of the server 10 stores information about the bet of the second user with a predetermined relationship with the first user (i.e., with a relationship belonging to the same group) for the race in the storage section 100 in association with the race. Here, the information about the bet of the second user includes information representing whether the second user has placed a bet, the betting content of the second user, and whether the bet placed by the second user is successful. The management section 106 generates data for displaying the list of the races stored in the storage section 100 in a display form corresponding to information about the bet of the second user on the terminal of the first user or second user. For example, the management section 106 generates data for displaying the list of the races stored in the storage section 100 in a display form where whether the second user has placed a bet or whether the bet is successful is identifiable for each race.

The identifiable display form is not limited as long as it is identifiable by the user on the display. For example, as illustrated in FIG. 15, the detailed information can be distinguished from other detailed information by displaying it with a broken line, a heavy line or the like in accordance with whether the second user has placed a bet or whether the bet is successful. Alternatively, the display form may be discriminated by different colors. For example, the displayed information can be distinguished from other detailed information by displaying the frame of the displayed detailed information with different colors in accordance with whether the second user has placed a bet or whether the bet is successful. The identifiable display form is not limited to the above-described examples, and may include other display forms.

At this time, the display form of detailed information about a race bet by the second user and the display form of detailed information about a race on which the second user has been successful in betting may be displayed in different forms. In this manner, the first user or the second user can identify whether the race is a race bet by the second user or a race on which the second user has been successful in betting, by only viewing the display form.

In addition, the management section 106 may generate data for displaying, in different display forms. information about the race bet by the second user and information about the race on which both the first user and the second user have been successful in betting. In this manner, the overview information is displayed on the terminal apparatus 20 in a form corresponding not only to whether the second user has placed a bet or whether the bet is successful, but also to the bet outcome of the first user and the second user.

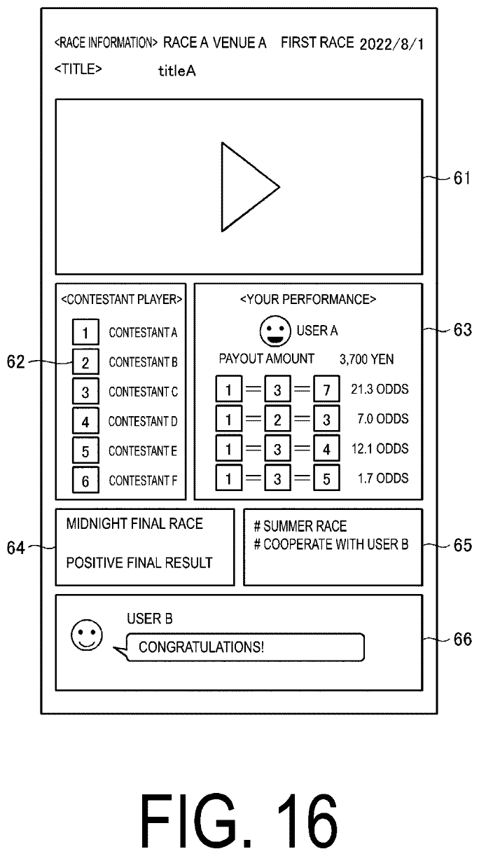

Next, an example of a display of detailed information of race history information is described. FIG. 16 is a diagram illustrating an example of a display of detailed information of the race history information.

For example, the first user performs an input operation of requesting detailed information about a history of a specific race in the Web browser provided in the first terminal apparatus 20a or the dedicated application installed in the first terminal apparatus 20a. On the basis of the input operation, the first terminal apparatus 20a requests screen data representing the detailed information from the server 10. At this time, the first terminal apparatus 20a transmits to the server 10 the user ID of the first user and the race ID of the race for which the detailed information has been requested. The management section 106 of the server 10 generates screen data for displaying on the first terminal apparatus 20a the detailed information about the history of the race from among the races stored in the storage section 100. More specifically, the management section 106 generates screen data for displaying on the first terminal apparatus 20a the race related to the received race ID and user ID in the information stored in the race history management DB100c of the storage section 100. The server 10 provides the first user with the generated screen data by transmitting it to the first terminal apparatus 20a via the communication IF 13. The first terminal apparatus 20a displays the detailed information on the display on the basis of the received screen data.

As illustrated in FIG. 16, information about a race itself of the specified betting target is displayed on the display screen of the detailed information, for example. That is, as illustrated in FIG. 16, the race name “race A”, the race venue “venue A”, the race number “first race”, and the race date and time “2022 Aug. 1” are displayed as the information about the race itself of the betting target. In addition, a title associated with the race is displayed as detailed information. The title is a title created by the first user, for example. Note that, the title may be edited by the first user on the display screen of the detailed information.

As illustrated in FIG. 16, a race archive (video) 61 associated with the race is displayed as detailed information. When the first user performs an input operation of playing the race archive on the display screen, the first terminal apparatus 20a plays the video of the race archive. In this manner, the first user can view videos of the past races.

As illustrated in FIG. 16, basic information 62 of the race is displayed as detailed information. In the example illustrated in FIG. 16, information about the contestant of the race is displayed as the basic information 62, but the content of the basic information 62 is not limited to the contestant and may include other information about the race. In addition, performance information 63 is displayed as detailed information. The content of the performance information 63 may be the same as the above-described performance information 51a.

As illustrated in FIG. 16, a comment 64 and tag information 65 are displayed as detailed information. The comment 64 and the tag information 65 are the comment 64 and the tag information 65, respectively, input by the first user, for example. The comment 64 and the tag information 65 may be edited by the first user on the display screen of the detailed information.

As illustrated in FIG. 16, response information 66 is displayed as detailed information. In the example illustrated in FIG. 16, a comment of another user is displayed as the response information 66. In the case where there is a plurality of the comments of another user, all comments may be displayed side by side along the time-series order of the comments input by another user, for example. Note that, not only the comment of another user, but also the betting action, contents and number of the evaluation response and the like may be displayed as the response information 66.

With the terminal apparatus 20 displaying the race history information in the above-described manner, the user viewing the race history information can easily recall the information about the race previously bet or responded by the user. This facilitates new communication between users such as talking about their memories of past races or inviting each other to place a bet on a race again.

Note that, regarding the viewing of the race history information, the first user may view only the race history information related to the first user, or the first user may view the race history information related to other users. For example, the first user may view the race history information related to the second user. There may be restrictions on viewing of the race history information related to other users, such as limiting the viewing to users belonging to the same group.

### Modifications

In the above-mentioned embodiment, the predetermined relationship between the users is a relationship belonging to the same group. However, the predetermined relationship may not be a relationship belonging to the same group. The predetermined relationship may include any relationships that can be stored in the server 10. The predetermined relationship may be a friend, for example. A friend is a bilateral relationship that is established when one user makes a friend request to the other user and the other user accepts the friend request, for example. The predetermined relationship may be a follow. A follow is a one-way bilateral relationship that is established when one user makes a follow request to the other user. The predetermined relationship may be user designation, for example. User designation is a one-way bilateral relationship that is established when one user designates the other user. The relationships between the users other than groups are also managed by the server 10 by storing the user IDs in association with each other in the group management DB100b, for example.

At step S19 illustrated in FIG. 6 in the above-mentioned embodiment, the management section 106 may control the provision of bet information to the second user on the basis of whether the first user and the second user have a predetermined relationship. More specifically, the management section 106 may provide the bet information to the second user when the first user and the second user has a relationship of the same group, friend, follow or user designation.

In the above-mentioned embodiment, the terminal apparatus 20 may receive input of information when a race is conducted. For example, when a race is conducted, the user plays a video of the race in real time using the terminal apparatus 20. At this time, the terminal apparatus 20 may receive input of ambient sound from a microphone serving as the input device 14. For example, the terminal apparatus 20 receives voice input from the user who is cheering while playing (viewing) a video of the race during the race. The input information that is received during a race is not limited to sound, but may be, for example, chat or other text, or pictograms representing facial expressions. The input information received by the terminal apparatus 20 during a race is transmitted to the server 10. The management section 106 of the server 10 further stores input information that is received by the user's terminal apparatus 20 in accordance with play of the video of the race in association with the race. Specifically, the management section 106 of the server 10 further stores input information that is received by the user's terminal apparatus 20 in accordance with play of the video of the race in association with the predetermined race ID in FIG. 6. Then, when the race archive (video) 61 illustrated in FIG. 16 is played, input information (e.g., the voice of a cheering user) that is received by the user's terminal apparatus 20 in accordance with play of the video of the race is played together with the video in association with the race. In this manner, the user can more clearly recall the situation during the race.

In the above-mentioned embodiment, the management section 106 may control whether to allow the second user belonging to the group where the first user belongs to view information about a stored race depending on whether the first user has granted permission. For example, it is assumed that the first user belongs to two groups, the first group and the second group. It is assumed that for a race bet by the first user, the first user, using the first terminal apparatus 20a, has allowed the first group to view the information about the race, but has not allowed the second group to view the information about the race. In this case, the information about whether to allow viewing set by the first user is stored in association with the race ID and the user ID of the first user. When the management section 106 acquires a request for viewing information about the race from other users belonging to the first group, the management section 106 provides the information about the race (e.g., such as screen data of FIG. 14 to FIG. 16) to the other users. On the other hand, when the management section 106 acquires a request for viewing information about the race from other users who belong to the second group but not to the first group, the management section 106 does not provide information about the race. In this manner, the first user can determine the openness in accordance with the race and betting content on their own.

In addition, the management section 106 may change the viewable information for each group. For example, in the case where the first user has set different viewable information for the first group and the second group, the management section 106 performs a control to limit the viewable information for each group in accordance with the set content.

In the above-mentioned embodiment, on the basis of the stored information about the race, the server 10 may provide data for displaying information about the race that satisfies a predetermined condition to a user having a predetermined relationship with a specific user at a predetermined timing. The following description assumes that the specific user is the first user. The predetermined condition may be any condition. For example, the predetermined condition is that the race is a race common to a race on which the first user has been successful in betting. The common content may be set as necessary, and may be the race venue, race date and time, the contestant and the like, for example. For example, the predetermined condition is that the number of responses is equal to or greater than a predetermined number. For example, the predetermined condition is that a predetermined period of time (e.g., 6 months or 1 year, etc.) has elapsed after the race has conducted. In addition, the predetermined timing may be any timing, and may be a timing that is determined to satisfy the predetermined condition by the management section 106, a preliminarily set periodic timing and the like, for example. In this manner, the information about the race that satisfies the predetermined condition is automatically provided to the user with a predetermined relationship with the first user. Thus, the user with a predetermined relationship with the first user can recognize that there is a race that satisfies the predetermined condition.

As an example, for example, the server 10 provides data for displaying information about the race that satisfies a condition that the number of responses is equal to or greater than a predetermined number and that a predetermined period of time (e.g., 6 months or 1 year, etc.) has elapsed after the race has conducted as the above-mentioned predetermined condition in the stored information about the race. In this manner, information about the race with high responses by other users, i.e., the number of responses equal to or greater than a predetermined number, is provided to the user with a predetermined relationship after a predetermined period has elapsed, and thus the user with the predetermined relationship can easily recall such information about the race.

In the above-mentioned embodiment, the response includes comments, evaluation responses and betting actions. However, the response is not limited to this. The response may include user's responses other than comments, evaluation responses and betting actions. In addition, the response may not include all of comments, evaluation responses and betting actions. For example, the response may include some of them as essential information. As an example, the response may include information other than betting actions (e.g., comments and evaluation responses) as essential information.

In the above-mentioned embodiment, the posting information is provided to the terminal apparatus 20 by the provision section 105. However, the provision section 105 may not directly provide the posting information to the terminal apparatus 20. For example, the provision section 105 may provide the posting information to the user's terminal apparatus 20 via other servers. In addition, the provision section 105 may provide the posting information in various forms such as e-mail transmission and posting on social networking services (SNS) as well as the forms of the above-mentioned embodiments.

### Display Example of Information Related to Other Users

Next, a display example of information related to other users is described. Other users mean other users for a user who uses the services provided in the information processing system 1. Thus, for example, other users for the first user are users other than the first user, including the second user. The information processing system 1 can present various information related to other users to the user by displaying it on the terminal apparatus 20. The following describes a display example of information related to other users from the first user's perspective.

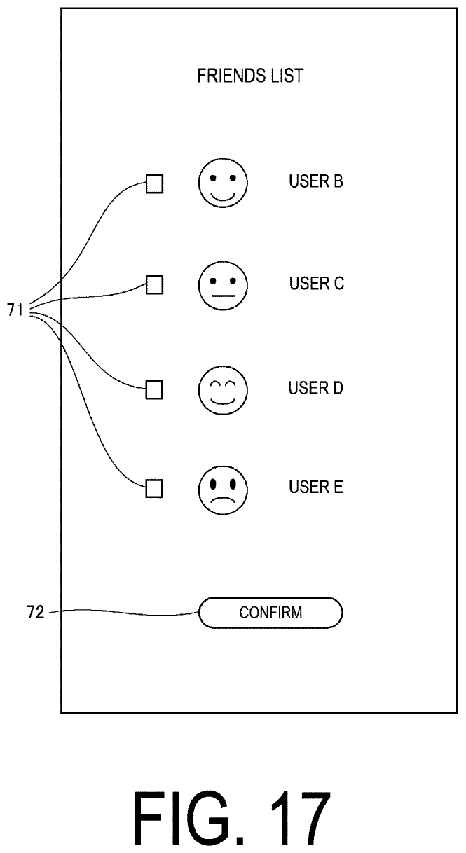

FIG. 17 is a diagram illustrating an example of the other user selection screen. When the first user performs a predetermined input operation for displaying the other user selection screen on the first terminal apparatus 20a, the first terminal apparatus 20a displays the screen illustrated in FIG. 17 based on data received from the server 10 on the basis of the input operation. Specifically, when the processor 11 of the server 10 receives a signal indicating that an input operation has been performed on the first terminal apparatus 20a, it generates the other user selection screen illustrated in FIG. 17 and transmits data of the other user selection screen to the first terminal apparatus 20a so as to display it on the first terminal apparatus 20a.

The other user selection screen is a screen for the first user to select a specific user from among a plurality of users. More specifically, the other user selection screen is a screen for the first user to select other users concerned when viewing information related to other users. As illustrated in FIG. 17, the other user selection screen displays information about other users in a list form. In the example illustrated in FIG. 17, icons and user names of other users are displayed as information about other users.

The other user selection screen may display information about all of users other than the first user, or information about a specific user other than the first user. The other specific user is a user who has a predetermined relationship with the first user, for example. In the example illustrated in FIG. 17, the other user selection screen displays information about other users, other than the first user, with a friend relationship with the first user. The condition for the other user displayed on the other user selection screen may be selected by the first user, for example. For example, the first user may select whether the other user selection screen displays information about all the other users, or information about users with a predetermined relationship. The server 10 that has the selectable configuration displays the information about other users that satisfy the condition on the other user selection screen on the basis of the condition input by the first user on the first terminal apparatus 20a.

The first user selects the desired other user from the list of other users displayed on the other user selection screen. In the example illustrated in FIG. 17, the other user selection screen displays entry fields 71 for selecting other users in the form of check boxes. It should be noted that, the entry field 71 may be displayed in a form other than the check box. In addition, in the case where a means for the first user to select other users are separately provided, the other user selection screen may not display the entry field 71. In the example illustrated in FIG. 17, the first user can select the desired other user by checking the check box of the desired other user. Note that, the upper limit may or may not be set for the number of other users that can be selected by the first user.

After selecting the desired other user, the selection of the other user is determined when the first user selects a confirm button 72 illustrated in FIG. 17. In this case, information about the user selected by the first user on the other user selection screen is transmitted from the first terminal apparatus 20a to the server 10. The processor 11 of the server 10 can specify the selected other user on the basis of the first user input operation. Specifically, in this example, the processor 11 of the server 10 can specify the other user selected by the first user from information transmitted from the first terminal apparatus 20a on the basis of the first user's selection operation for the other user at the entry field 71 on the other user selection screen and selection operation at the confirm button 72. It is assumed here that the first user has selected the second user with the user name “user B”as the other user.

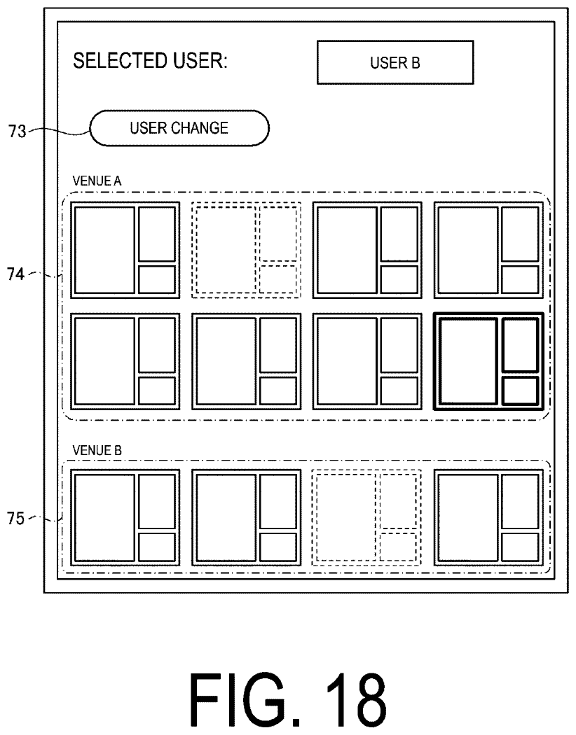

After specifying the other user, the processor 11 of the server 10 causes the first terminal apparatus 20a to display the race history information about the first user related to the specified other user. FIG. 18 is a diagram illustrating a display screen example of the race history information related to another user. The processor 11 of the server 10 causes the first terminal apparatus 20a to display the display screen illustrated in FIG. 18, for example. More specifically, FIG. 18 is a screen that displays a list of races bet by the first user. The screen that displays the list of races illustrated in FIG. 18 indicates the race history information related to the other the user (here, the second user) selected by the first user.

When displaying the display screen illustrated in FIG. 18, the processor 11 of the server 10 refers to the information stored in the storage apparatus 12 of the server 10. For example, the storage apparatus 12 stores the information described above with reference to FIG. 4 to FIG. 6. More specifically, the storage apparatus 12 stores information about one or more races bet by the first user, and information about one or more races bet by a user other than the first user. With reference to the storage apparatus 12, the processor 11 extracts information about the race bet by the first user and information about the race bet by the selected other user (here, the second user) and generates the display screen illustrated in FIG. 18 on the basis of the extracted information. The processor 11 displays the generated display screen on the first terminal apparatus 20a.

The display screen displays information about the selected user as illustrated in FIG. 18, for example. The selected user is the other user selected by the first user, and is, in this example, the second user. The information about the selected user may be any information that can identify the selected user, and is, in the example illustrated in FIG. 18, “user B” that is the user name of the second user.

As illustrated in FIG. 18, the display screen may display a user change button 73. The user change button is a button for changing the other user to be selected. The first user operates the user change button 73 when switching the other user to be selected from the second user to a user other than the second user. When the user change button 73 is operated, the processor 11 of the server 10 displays the other user selection screen illustrated in FIG. 17 on the first terminal apparatus 20a, for example. On the other user selection screen, the first user can change the other user to be selected from the second user to a user other than the second user.

The display screen of the race history information displays the list of the race history information by the race venue. For example, in the example illustrated in FIG. 18, overview information about race history related to the race conducted at the race venue A and the race conducted at the race venue B are displayed. Note that, the display content of the overview information may be the same as the overview information 52 described with reference to FIG. 14, and therefore the description thereof is omitted here.

Display screen of the race history information includes one or more display regions for displaying each of one or more races bet by the user as illustrated in FIG. 18, for example. More specifically, in the example illustrated in FIG. 18, the display screen includes a display region 74 that displays the race conducted at the race venue A bet by the user and a display region 75 that displays the race conducted at the race venue B bet by the user. In this manner, the display screen may include the display region that displays the race bet by the user by the race venue. Note that, FIG. 18 illustrates the display region 74 and the display region 75 with dashed-dotted lines for easy understanding of description, but dashed-dotted lines may not be displayed on the screen actually displayed by the first terminal apparatus 20a.

The processor 11 of the server 10 controls at least one of the display form and the display position of one or more display regions on the basis of whether the second user has placed a bet on one or more races bet by the first user in the information stored in the storage apparatus 12. For example, the processor 11 displays the overview information about the race bet by the first user and the second user in a form different from that of the overview information about the race bet by the first user but not by the second user. As an example, as illustrated in FIG. 18, the processor 11 displays the overview information about the race bet by the first user and the second user with a broken line, and displays the overview information about the race bet by the first user but not by the second user with a thin solid line. It should be noted that the display form is not limited to this, and any identifiable display forms may be used. As described above, the identifiable display form needs only to be identifiable by the user on the display.

Further, the processor 11 of the server 10 controls at least one of the display form and the display position of one or more display regions on the basis of whether the bets placed by the first user and the second user on one or more races bet by the first user are both successful in the information stored in the storage apparatus 12. For example, the processor 11 can display the overview information about the race on which both the first user and the second user have been successful in betting in a form different from that of the overview information about the race bet by at least one of the first user and the second user is not successful. As an example, as illustrated in FIG. 18, the processor 11 displays the overview information about the race on which both the first user and the second user have been successful in betting with a thick solid line, and the overview information about the race bet by at least one of the first user and the second user is not successful with a broken line. It should be noted that the display form is not limited to this, and any identifiable display forms may be used.

In the following, in this description, the display form of the race on which both the first user and the second user have been successful in betting (the form corresponding to the thick solid line of FIG. 18) is referred to also as first form, the display form of the race bet by the first user and the second user (the form corresponding to the broken line of FIG. 18) as second form, and the display form of the race bet by the first user but not by the second user (the form corresponding to the thin solid line of FIG. 18) as third form.

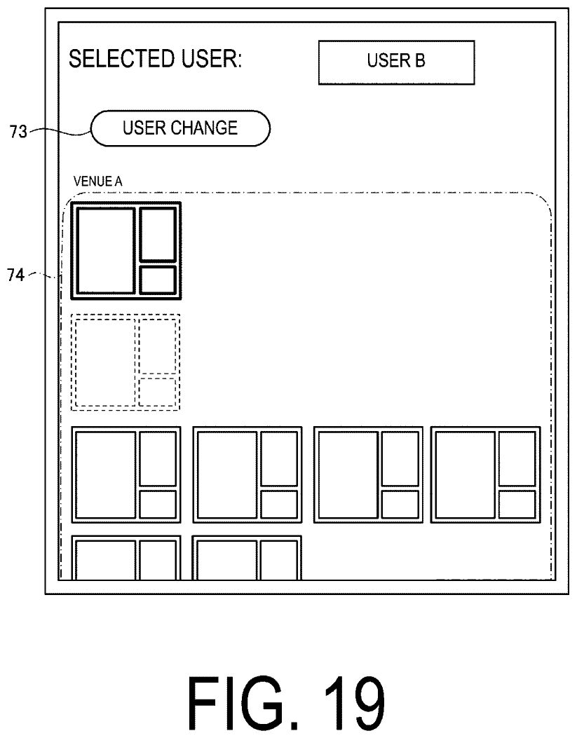

FIG. 19 is a diagram illustrating another display screen example of the race history information related to another user. More specifically, FIG. 19 is a display screen example in which the display position is controlled in addition to the display form of the overview information in the display screen illustrated in FIG. 18. Specifically, in the example illustrated in FIG. 19, the processor 11 displays the overview information about the race on which both the first user and the second user in the first form have been successful in betting (with a thick solid line) at the uppermost position in the display region 74. In addition, the processor 11 displays the overview information about the race bet by the first user and the second user in the second form (broken line) at the second uppermost position next to the overview information about the race on which both the first user and the second user have been successful in betting in the display region 74. Further, the processor 11 displays the overview information about the race bet by the first user but not by the second user in the third form (thin solid line) at the lowermost position in the display region 74.

As described above with reference to FIG. 18, by controlling at least one of the display form and display position in accordance with the bet status of the selected other user (second user) in the races bet by the first user, the first user can easily recognize whether the race bet by the first user has been bet by other users. In this manner, it is possible to provide a GUI with which whether the race bet by the user is bet by other users can be easily recognized. In addition, as described above with reference to FIG. 19, by controlling at least one of the display form and display position in accordance with the outcome of the selected other user (second user) in the races bet by the first user, the first user can easily recognize the race on which both the first user and the other user have been successful in betting.

In the case where the first user has selected a user other than the second user as the other user, the display form or display position in the display region changes in accordance with the bet status and outcome of placed by the user other than the second user.

The processor 11 of the server 10 may display a display screen different from the screens illustrated in FIGS. 18 and 19 on the first terminal apparatus 20a. For example, the processor 11 displays a display screen of the list of race venues where one or more races bet by the first user have been conducted on the first terminal apparatus 20a of the first user. The processor 11 displays the list of race venues on the display screen when a predetermined input operation for displaying the list of race venues is performed by the first user, for example.

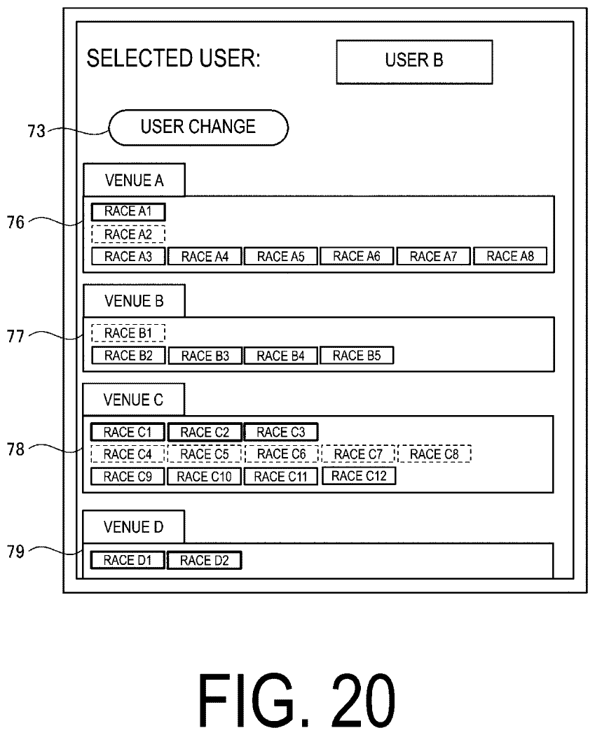

FIG. 20 is a diagram illustrating a display screen example of the list of race venues. Also in the case where the list of race venues is displayed, the first user may designate the other user as with the display screens described with reference to FIGS. 18 and 19 are displayed. Therefore, as illustrated in FIG. 20, the display screen of the list of race venues may display information about the selected user (Here, the user name “user B”), and the user change button 73, for example.

FIG. 20 illustrates the venue A, venue B, venue C and venue D in the list of race venues. As illustrated in FIG. 20, the display screen of the list of race venues is provided with display regions for displaying races conducted in the race venue for each race venue, for example. More specifically, a display region 76 for the venue A, a display region 77 for the venue B, a display region 78 for the venue C, and a display region 79 for venue D are provided.

The display regions 76 to 79 display the information about the race bet by the first user in the races conducted in respective race venues. In the example illustrated in FIG. 20, the race names such as “race A1” are illustrated as the information about the race bet by the first user, but the information about the race is not limited to this, and may be displayed in any ways with which the races can be recognized, for example. For example, the information about the race may be displayed as overview information as in FIGS. 18 and 19.

The information about the race is displayed in the above-described first to third forms in accordance with the bet status and/or the outcome of the first user and the second user as illustrated in FIG. 20, for example. In addition, in each display region, each race is displayed with the display position controlled in accordance with the bet status and/or the outcome of the first user and the second user as illustrated in FIG. 20, for example. That is, in the example illustrated in FIG. 20, the information about the race on which both the first user and the second user have been successful in betting is positioned at the uppermost position, the information about the race bet by the first user and the second user at the second uppermost position, and the information about the race bet by the first user but not by the second user at the lowermost position.

The processor 11 of the server 10 rearranges the display regions of the race venues in the display screen of the list of race venues on the basis of a predetermined input operation of the first user on the first terminal apparatus 20a. The processor 11 rearranges the display regions in accordance with a predetermined rule.

For example, the processor 11 rearranges the display regions so as to preferentially display a display region that displays a race venue with a large number of races on which both the first user and the second user have been successful in betting, over a display region that displays a race venue with a small number of races on which a successful bet is placed by both the first user and the second user. More specifically, the processor 11 rearranges the display regions so as to display the display region that displays a race venue with a large number of races on which both the first user and the second user have been successful in betting (i.e., the race displayed in the first form) at an upper position relative to a display region that displays a race venue with a small number of races on which both the first user and the second user have been successful in betting. In other words, the processor rearranges the display regions so as to position a display region that displays a race venue with a larger number of races on which both the first user and the second user have been successful in betting at an upper position.

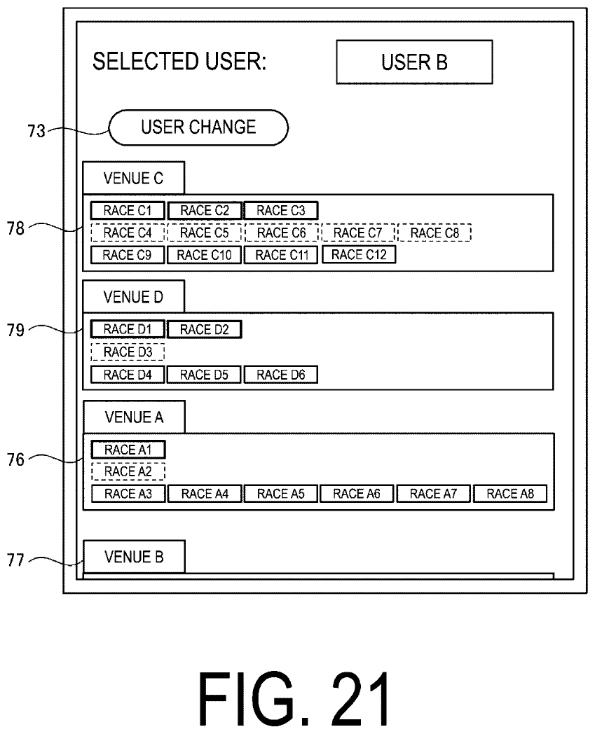

FIG. 21 is a diagram illustrating an example of rearrangement of display regions of race venues, or more specifically, an example of rearrangement of the display regions of the race venues illustrated in FIG. 20. In the example illustrated in FIG. 20, the number of races on which both the first user and the second user have been successful in betting is one in the venue A, zero in the venue B, three in the venue C, and two in the venue D. The processor 11 rearranges the display regions by the number of races on which both the first user and the second user have been successful in betting, and therefore rearranges the display regions in the order of the display region 78 displaying the venue C, the display region 79 displaying the venue D, the display region 76 displaying the venue A, and the display region 77 displaying the venue B as illustrated in FIG. 21. Through this rearrangement, the first user can easily determine a race venue with a larger number of races on which the first user, together with the second user, has been successful in betting.

Note that, the processor 11 may not rearrange the display regions on the basis of the number of races on which both the first user and the second user have been successful in betting. For example, the processor 11 may rearrange the display regions on the basis of the number of the races bet by the first user and the second user, or rearrange the display regions on the basis of the number of the races bet by the first user but not by the second user. Alternatively, the reference for rearrangement of the display regions may be selected by the first user. In this case, the processor 11 rearranges the display regions on the basis of the reference selected by the first user.

On the basis of the input operation on the display screen of the list of race venues, the processor 11 of the server 10 displays the information about the race conducted at the race venue specified by the input operation (hereinafter referred to also as “specific race venue”) on the first terminal apparatus 20a of the first user. For example, the first user performs an input operation of selecting a specific race venue where the first user wishes to view the information about the race on the display screen of the list of race venues illustrated in FIG. 20 or FIG. 21. More specifically, the first user performs an input operation of selecting any of the display regions 76 to 79. When a signal indicating that an input operation has been made is transmitted from the first terminal apparatus 20a to the server 10, the processor 11 of the server 10 specifies the selected specific race venue on the basis of the input operation. Referring to the storage apparatus 12, the processor 11 generates a display screen that displays information about a race conducted at a specific race venue and transmits the data of the generated display screen to the first terminal apparatus 20a, thereby displaying the display screen on the first terminal apparatus 20a. The information about a race conducted at a specific race venue may include the races previously conducted at the specific race venue, a race bet by the first user or a race on which the first user has been successful in betting among the races previously conducted at the specific race venue, a race to be conducted at specific race venue and the like.

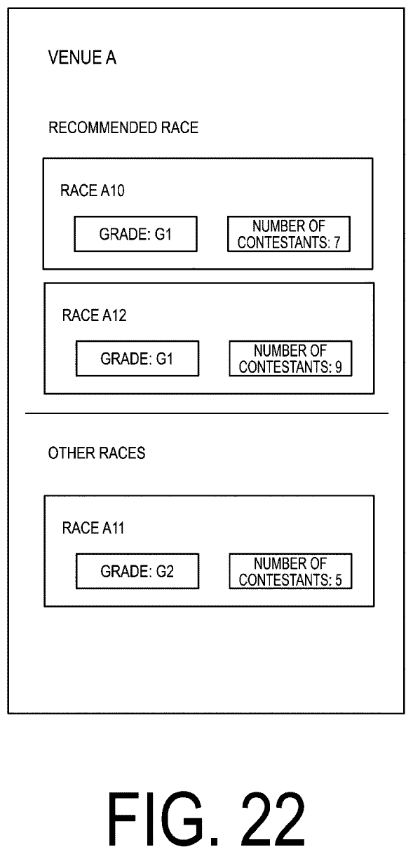

FIG. 22 is a diagram illustrating an example of a display screen that displays information about a race conducted at a specific race venue. More specifically, FIG. 22 illustrates an example of a display screen that displays information about the race venue A. That is, in the case where the first user selects the race venue A as a specific race venue, the display screen illustrated in FIG. 22 is displayed, for example.

The processor 11 of the server 10 displays information about the race that is conducted at the specific race venue and can be bet by the first user on the first terminal apparatus 20a of the first user. Accordingly, at the time when the information is viewed, the information about a race conducted at a specific race venue includes the information about the race to be conducted at the specific race venue. The information about the race that is conducted at the specific race venue and can be bet by the first user is displayed in a list form of corresponding races, for example. The first user can place a bet on a race to be conducted by performing a predetermined input operation on the first terminal apparatus 20a.

The processor 11 of the server 10 can display, on the first terminal apparatus 20a of the first user in a recommendation form for recommendation to the first user, a race similar to the race on which both the first user and the second user have been successful in betting among the races that are conducted at the specific race venue and can be bet by the first user in the information stored in the storage apparatus 12. On the basis of a predetermined reference, the processor 11 can extract a race similar to the race on which both the first user and the second user have been successful in betting. For example, the processor 11 extracts, as a similar race, a race common to the race on which both the first user and the second user have been successful in betting in at least a part of the condition of the race among the races that are conducted at the specific race venue and can be bet by the first user. The condition of the race may include at least one of the grade of the race, the number of contestants of the race, and the distance of the race, for example. It should be noted that, the condition of the race is not limited to this, and may include other conditions. It is assumed here that the condition of the race is the grade of the race.

For example, it is assumed that in the race previously conducted at the venue A as the specific race venue, the grade of the race on which both the first user and the second user have been successful in betting is G1. In this case, referring to the storage apparatus 12, the processor 11 extracts, as a similar race, a race whose grade is G1 from among the races that are conducted at the venue A and can be bet by the first user.

The processor 11 displays the extracted similar race in a recommendation form on the first terminal apparatus 20a. The recommendation form may be any form with which the first user can recognize the recommendation. For example, the recommendation form may be a form including letters, diagram, color, effect and the like.

In this example, the first user performs an input operation of selecting the venue A as a specific race venue on the display screen of the list of race venues illustrated in FIG. 20 or FIG. 21, and accordingly the processor 11 of the server 10 displays the information about the race that is conducted at the venue A on the first terminal apparatus 20a as illustrated in FIG. 22. In the example illustrated in FIG. 22, the information about the race that can be bet by the first user, i.e., “race A10”, “race A11” and “race A12” are illustrated as the information about the race that is conducted at the venue A. In this manner, the first user can easily view the information about the race that is conducted at the venue A that is the specific race venue where the previously bet race has been conducted. Since the specific race venue can be selected, for example, with reference to the display screen of the list of race venues illustrated in FIG. 20 or FIG. 21, the first user can select the race venue of a race on which the first user, together with the second user, has been successful in betting as the specific race venue. In this manner, the user is easily motivated to place a bet together with the second user again.

In FIG. 22, the grades of the “race A10” and “race A12” are G1 among “race A10”, “race A11” and “race A12”, and therefore the processor 11 extracts the races as races similar to the race on which both the first user and the second user have been successful in betting. Therefore, as illustrated in FIG. 22, “race A10” and “race A12” extracted as a similar race are indicated in a column in the recommendation form “recommended race”. In this manner, the first user can easily recognize a race similar to past races on which the first user, together with the second user, has been successful in betting. Thus, the first user can be easily motivated to place a bet on a similar race together with the second user.

The first user can place a bet on a race conducted at a specific race venue from a display screen that displays information about a race conducted at a specific race venue as illustrated in FIG. 22, for example. More specifically, the first user can place a bet by inputting a betting content into the first terminal apparatus 20a. When the first user places a bet, the data on the betting content is transmitted from the first terminal apparatus 20a to the server 10. The processor 11 of the server 10 receives the bet by receiving the data on the betting content. When receiving the bet, the processor 11 displays the race bet by the first user and betting content information on the second terminal apparatus 20b of the second user.

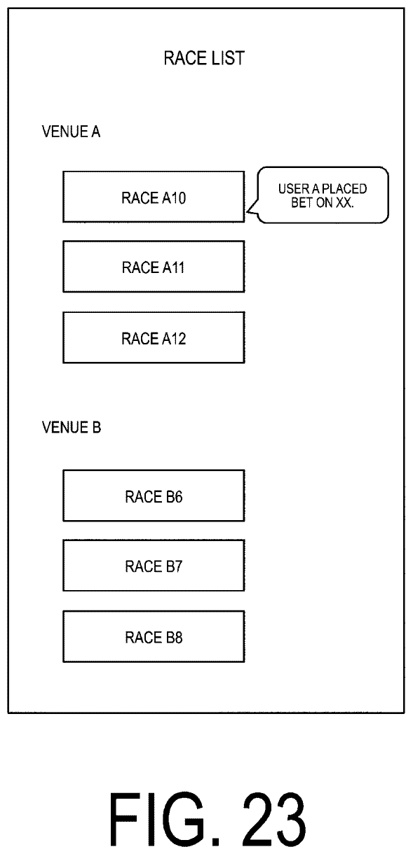

FIG. 23 is a diagram illustrating a display screen example of information about a race bet by the first user and a betting content displayed on the second terminal apparatus 20b. As illustrated in FIG. 23, the second terminal apparatus 20b displays a list of races on which the second user can place a bet, for example. The processor 11 can display the race bet by the first user and betting content information in the list of races displayed on the second terminal apparatus 20b.

For example, it is assumed here that the first user has placed a bet on a contestant “XX” who participates in “race A10”. In this case, as illustrated in FIG. 23, for example, the second terminal apparatus 20b displays “user A placed bet on XX” as the race bet by the first user and betting content information. Note that, the user A is the user name of the first user. The display form of the race bet by the first user and betting content information on the second terminal apparatus 20b is not limited to this, and may be any other forms. In this manner, with the race bet by the first user and betting content information displayed, the second user can recognize the betting action of the first user who has previously placed a bet on a race together, or has been successful in betting a race. In this manner, the second user can also be easily motivated to place a bet.

When the second user performs an input operation of selecting a race bet by the first user and betting content information displayed on the second terminal apparatus 20b, the processor 11 of the server 10 may display further detailed information about the betting content of the first user on the second terminal apparatus 20b on the basis of the input operation.

Note that, for example, in the screen of the race list illustrated in FIG. 23, the processor 11 of the server 10 can perform rearrangement of the displayed race through a predetermined input operation of the second user on the second terminal apparatus 20b. For example, as illustrated in FIG. 23, the processor 11 may rearrange the races by the race venue, by the conducted date and time, or by the condition designated by the second user.

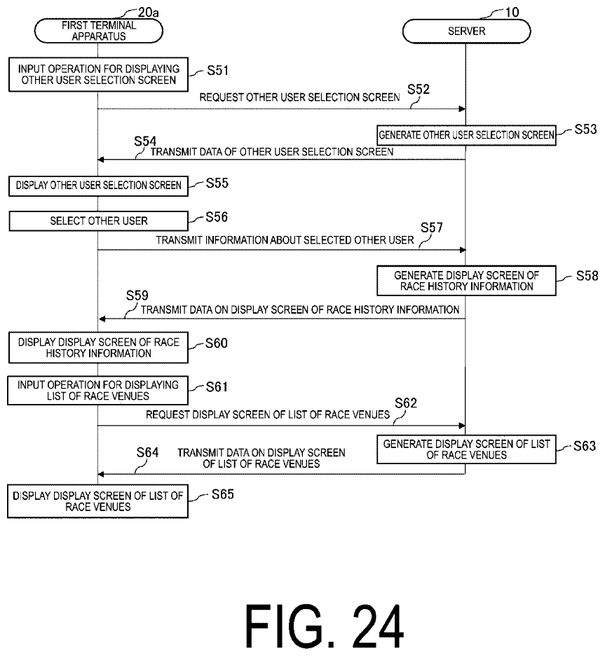

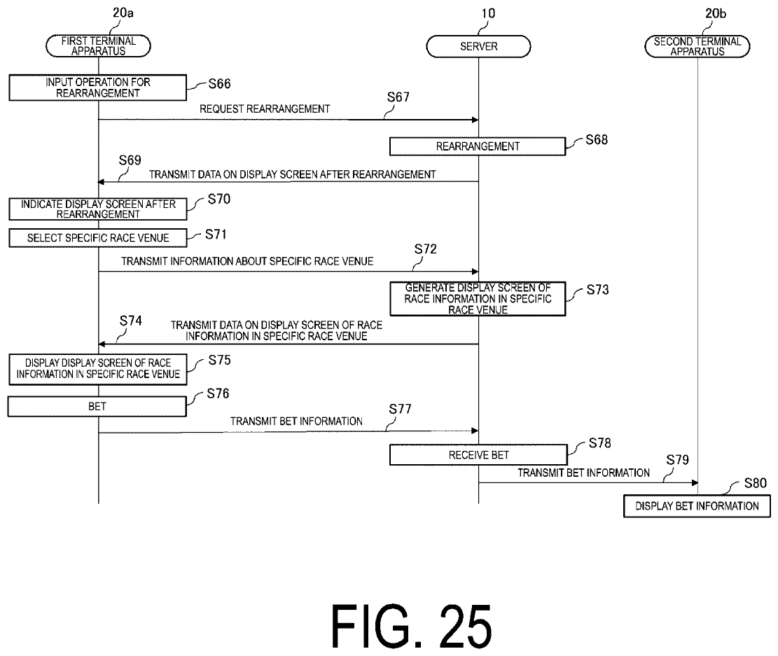

FIGS. 24 and 25 are sequence diagrams illustrating an example of a processing procedure that is executed when displaying information related to other users.

For example, the first terminal apparatus 20a receives an input operation of the first user for displaying the other user selection screen (step S51). On the basis of the reception of the input operation, the first terminal apparatus 20a transmits a signal that requests the other user selection screen to the server 10 (step S52). When the server 10 receives from the first terminal apparatus 20a a signal that requests the other user selection screen, the server 10 generates the other user selection screen referring to the storage apparatus 12 on the basis of the signal (step S53). The server 10 transmits the generated data on the other user selection screen to the first terminal apparatus 20a (step S54). The first terminal apparatus 20a displays the other user selection screen on the basis of data of the other user selection screen received from the server 10 (step S55). For example, the first terminal apparatus 20a displays the screen illustrated in FIG. 17.

When the first user performs an input operation of selecting the other user on the other user selection screen, the first terminal apparatus 20a receives the input operation of selecting the other user (step S56). The first terminal apparatus 20a transmits the information about the other user selected through the input operation to the server 10 (step S57). For example, when the first user has selected the second user as the other user, the first terminal apparatus 20a transmits to the server 10 information that indicates that the second user has been selected as the other user.

The server 10 generates a display screen of the race history information bet by the first user on the basis of the information about the other user received from the first terminal apparatus 20a (step S58). At this time, the server 10 controls at least one of the display form or display position of the display region for the race bet by the first user on the basis of whether the selected other user has placed a bet. The server 10 transmits the generated data on the display screen of the race history information to the first terminal apparatus 20a (step S59). The first terminal apparatus 20a displays a display screen of the race history information on the basis of the data on the display screen of the race history information received from the server 10 (step S60). The first terminal apparatus 20a displays the display screen illustrated in FIG. 18 or FIG. 19, for example. Note that, the server 10 may switch the display screen displayed on the first terminal apparatus 20a between FIG. 18 and FIG. 19 on the basis of a predetermined input operation of the first user.

In addition, when the first user performs an input operation for displaying the list of race venues, the first terminal apparatus 20a receives an input operation for displaying the list of race venues (step S61). The first terminal apparatus 20a transmits a signal that requests a display screen of the list of race venues to the server 10 (step S62). The server 10 generates a display screen of the list of race venues on the basis of the signal received from the first terminal apparatus 20a (step S63). The server 10 transmits data on the display screen of the list of race venues to the first terminal apparatus 20a (step S64). The first terminal apparatus 20a displays a display screen of the list of race venues on the basis of the data on the display screen of the list of race venues received from the server 10 (step S65). The first terminal apparatus 20a displays the display screen illustrated in FIG. 20, for example.

Next, it is assumed that the first user has performed an input operation for rearranging the display regions of the race venues. The first terminal apparatus 20a receives an input operation of the first user for rearrangement (step S66). The first terminal apparatus 20a transmits a signal that requests rearrangement of the display regions to the server 10 on the basis of the received input operation (step S67). The server 10 rearranges the display regions in accordance with a predetermined rule on the basis of the signal received from the first terminal apparatus 20a (step S68). In this manner, the server 10 generates a display screen of the list of race venues after rearrangement. The server 10 transmits data on the display screen of the list of race venues after rearrangement to the first terminal apparatus 20a (step S69). The first terminal apparatus 20a displays the display screen of the list of race venues on the basis of the data on the display screen of the list of race venues after rearrangement received from the server 10 (step S70). The first terminal apparatus 20a displays the display screen display illustrated in FIG. 21, for example.

It is assumed that the first user has performed an input operation of selecting a specific race venue in the display screen of the list of race venues after rearrangement as illustrated in FIG. 21. On the basis of the input operation, the first terminal apparatus 20a receives a selection of a specific race venue (step S71). The first terminal apparatus 20a transmits information about the selected specific race venue to the server 10 (step S72). The server 10 generates a display screen of the information about the race conducted at the specific race venue on the basis of the information about the specific race venue received from the first terminal apparatus 20a (step S73). The server 10 transmits data on the display screen of the information about the race conducted at the specific race venue to the first terminal apparatus 20a (step S74). The first terminal apparatus 20a displays the display screen of the information about the race conducted at the specific race venue on the basis of the data on the display screen of the information about the race conducted at the specific race venue received from the server 10 (step S75). For example, the first terminal apparatus 20a displays the display screen illustrated in FIG. 22.

When the first user places a bet on a race conducted at the specific race venue from the display screen of the information about the race conducted at the specific race venue, the first terminal apparatus 20a receives the bet (step S76). The first terminal apparatus 20a transmits the received bet information related to the bet to the server 10 (step S77). The server 10 receives the bet placed by the first user by storing the bet information received from the first terminal apparatus 20a in the storage apparatus 12, for example (step S78). Then, the server 10 transmits the bet information of the first user to the second terminal apparatus 20b (step S79). The server 10 may transmit the bet information of the first user to the second terminal apparatus 20b either by a push method or a pull method. The second terminal apparatus 20b displays the bet information of the first user on the basis of the information received from the server 10 (step S80). The second terminal apparatus 20b displays the race bet by the first user and betting content information as the bet information of the first user. The second terminal apparatus 20b displays the bet information of the first user by the display screen illustrated in FIG. 23, for example.

Although the present embodiment has been described in detail above, it will be readily understood by those skilled in the art that many variations are possible that do not substantively depart from the novelties and effects of the present embodiment. Accordingly, all such variations shall be included within the scope of this disclosure. For example, a term that is mentioned at least once in the specification or drawings together with a different term that is broader or synonymous may be replaced by that different term at any point in the specification or drawings. All combinations of the present embodiments and variations are also included in the scope of this disclosure. The configuration and operation of the information processing system, information processing device, terminal apparatus, and the like are also not limited to those described in the present embodiment, and various variations can be implemented. The elements of the above embodiments can be combined as appropriate.

### Overview

### General Purpose

An object of the present invention is to easily manage data.

In addition, an object of the present invention is to easily manage information about a race bet by the user.

An object of the present invention is to provide a technique for easily managing a record of communications with other users regarding a race bet by the user.

[Supplementary Note 1] An information processing device according to the present embodiment includes a bet information acquiring section that acquires bet information representing the information about the race bet by the first user, a response acquiring section that acquires response information representing a response from the second user to the bet information, and a management section that stores the response information in association with the race.

With the above-mentioned information processing device, it is possible to easily manage a record of communications with other users regarding a race bet by the user.

An object of the present invention is to easily manage the response for each bet.

[Supplementary Note 2] The information processing device according to Supplementary Note 1, in which the management section stores the bet information and the response information in association with the race.

In this manner, it is possible to easily manage the response for each bet.

An object of the present invention is to enable the other user to view the bet information of the user.

[Supplementary Note 3] The information processing device according to Supplementary Note 1 further includes a posting information generation section that generates posting information corresponding to the bet information, and a provision section that provides the posting information to the second user.

In this manner, it is possible to enable the other user to view the bet information of the user.

An object of the present invention is to enable the other user to view the response of the user.

[Supplementary Note 4] The information processing device according to Supplementary Note 3, in which the posting information generation section further generates posting information corresponding to the response information, and the provision section provides posting information corresponding to the response information to the first user.

In this manner, it is possible to enable the other user to view the response of the user.

An object of the present invention is to easily manage the provision target of the bet information.

[Supplementary Note 5] The information processing device according to Supplementary Note 1, in which the management section controls provision of the bet information to the second user on the basis of whether the first user and the second user have a predetermined relationship.

In this manner, it is possible to easily manage the provision target of the bet information.

An object of the present invention is to easily manage a record of communications using bet information or the outcome of the bet.

[Supplementary Note 6] The information processing device according to Supplementary Note 1, in which the bet information includes at least one of the betting content of the bet placed by the first user for the race, and the outcome of the bet placed by the first user related to the race.

In this manner, it is possible to easily manage a record of communications using bet information or the outcome of the bet.

An object of the present invention is to easily manage a record of communications using responses of betting actions.

[Supplementary Note 7] The information processing device according to Supplementary Note 1, in which the response includes the betting action of the second user for the race.

In this manner, it is possible to easily manage a record of communications using responses of betting actions.

An object of the present invention is to easily manage a record of a betting action as a response.

[Supplementary Note 8] The information processing device according to Supplementary Note 7, in which the betting action of the second user is betting on the same target as the betting target of the first user.

In this manner, it is possible to easily manage a record of a betting action as a response.

An object of the present invention is to enable the user to easily recall past races.

[Supplementary Note 9] The information processing device according to Supplementary Note 1, in which the management section further stores a video of the race in association with the race.

In this manner, it is possible to enable the user to easily recall past races.

An object of the present invention is to enable the user to easily recall conditions at a past race.

[Supplementary Note 10] The information processing device according to Supplementary Note 9, in which the management section further stores the input information received at the terminal apparatus of the first user or the second user in accordance with play of the video of the race in association with the race.

In this manner, it is possible to enable the user to easily recall conditions at a past race.

An object of the present invention is to enable the user to easily confirm bet information between the users in a predetermined relationship for each race.

[Supplementary Note 11] The information processing device according to Supplementary Note 1, in which the management section further stores information about the bet of the second user with a predetermined relationship with the first user for the race in association with the race, and the management section generates data for displaying a list of the stored races in a display form corresponding to information about the bet of the second user on the terminal of the first user or second user.

In this manner, it is possible to enable the user to easily confirm bet information between the users in a predetermined relationship for each race.

An object of the present invention is to enable the user to easily confirm whether a bet has been placed or whether a bet has been successful between the users in a predetermined relationship for each race.

[Supplementary Note 12] The information processing device according to Supplementary Note 11, in which the information about the bet of the second user includes information representing whether the second user has placed a bet or whether the bet is successful, and the management section generates data for displaying the list of the stored races in display form where whether a bet has been placed or whether the bet is successful is identifiable for each race.

In this manner, it is possible to enable the user to easily confirm whether a bet has been placed or whether a bet has been successful between the users in a predetermined relationship for each race.

An object of the present invention is to enable the user to easily find a successful race together with the other user.

[Supplementary Note 13] The information processing device according to Supplementary Note 12, in which the management section generates data for displaying, in different display forms, the information about the race bet by the second user, and the information about the race on which both the first user and the second user have been successful in betting.

In this manner, it is possible to enable the user to easily find a successful race together with the other user.

An object of the present invention is to impose limitation on viewing of information for each group.

[Supplementary Note 14] The information processing device according to Supplementary Note 1, wherein the management section controls whether to allow the second user belonging to the group where the first user belongs to view information about a stored race depending on whether the first user has granted permission.

In this manner, it is possible to impose limitation on viewing of information for each group.

An object of the present invention is to enable the user to easily recognize a race that satisfies a predetermined condition.

[Supplementary Note 15] The information processing device according to Supplementary Note 1, in which on the basis of the stored information about the race, data for displaying the information about the race that satisfies a predetermined condition is provided to the user with a predetermined relationship with the first user at a predetermined timing.

In this manner, it is possible to enable the user to easily recognize a race that satisfies a predetermined condition.

An object of the present invention is to enable the user to easily recognize a race with a large number of responses after a predetermined period of the race.

[Supplementary Note 16] The information processing device according to Supplementary Note 15, in which in the stored information about the race, data for displaying the information about the race that satisfies a condition that the number of responses is equal to or greater than a predetermined number and that a predetermined period has elapsed after the race has conducted is provided as the predetermined condition is provided.

In this manner, it is possible to enable the user to easily recognize a race with a large number of responses after a predetermined period of the race.

An object of the present invention is to provide a technique for easily managing a record of communications with other users regarding a race bet by the user.

[Supplementary Note 17] In an information processing method according to the present embodiment, a processor acquires bet information representing the information about the race bet by the first user, the processor acquires response information representing a response from the second user to the bet information, and the processor stores the response information in association with the race.

With the above-mentioned information processing method, it is possible to easily manage a record of communications with other users regarding a race bet by the user.

An object of the present invention is to provide a technique for easily managing a record of communications with other users regarding a race bet by the user.

[Supplementary Note 18] In a program according to the present embodiment, a processor is caused to acquire bet information representing the information about the race bet by the first user, the processor is caused to acquire response information representing a response from the second user to the bet information, and the processor is caused to store the response information in association with the race.

With the above-mentioned program, it is possible to easily manage a record of communications with other users regarding a race bet by the user.

An object of the present invention is to provide a technique for easily managing a record of communications with other users regarding a race bet by the user.

[Supplementary Note 19] In a program according to the present embodiment, the processor is caused to acquire posting information corresponding to the information about the race bet by the first user, or posting information corresponding to the response including information other than the betting action for the race by the second user from the second user for the bet information, and to execute a process of displaying the posting information.

With the above-mentioned information processing device, it is possible to easily manage a record of communications with other users regarding a race bet by the user.

An object of the present invention is to provide a technique of configuring a graphical user interface (GUI) with which whether the race bet by the user is bet by other users can be easily recognized.

[Supplementary Note 20] An information processing device according to the present embodiment includes: a processor; and a storage, in which the storage stores information about one or more races bet by a first user and information about one or more races bet by a second user, and the processor causes a terminal apparatus of the first user to display a first screen, the first screen displaying a list of the one or more races bet by the first user and including one or more display regions that respectively display one or more races bet by the first user, and controls at least one of a display form and a display position of the one or more display regions based on whether the one or more races bet by the first user are bet by the second user in the information stored in the storage.

With the above-mentioned information processing device, it is possible to easily recognize whether the race bet by the user is bet by other users.

An object of the present invention is to provide a GUI with which a race on which a successful bet has placed together with the other user can be easily recognized.

[Supplementary Note 21] The information processing device according to Supplementary Note 20, in which the processor controls at least one of the display form and the display position of the one or more display regions based on whether both the first user and the second user have been successful in betting on the one or more races bet by the first user in the information stored in the storage.

In this manner, it is possible to provide a GUI with which a race on which a successful bet has placed together with the other user can be easily recognized.

An object of the present invention is to provide a GUI with which whether a race bet by the user is bet by another specific user can be easily recognized.

[Supplementary Note 22] The information processing device according to Supplementary Note 20, in which the processor causes the terminal apparatus of the first user to display a second screen for selecting the second user from among a plurality of users, and specifies the second user based on an input operation on the second screen.

In this manner, it is possible to provide a GUI with which whether a race bet by the user is bet by another specific user can be easily recognized.

An object of the present invention is to provide a GUI with which information about a race in a race venue where the user has previously placed a bet can be easily viewed.

[Supplementary Note 23] The information processing device according to Supplementary Note 20, in which the processor causes the terminal apparatus of the first user to display a third screen that displays a list of race venues where the one or more races bet by the first user have been conducted, and causes the terminal apparatus of the first user to display, based on an input operation on the third screen, information about a race conducted at a specific race venue specified by the input operation.

In this manner, it is possible to provide a GUI with which information about a race in a race venue where the user has previously placed a bet can be easily viewed.

An object of the present invention is to provide a GUI with which a race venue with a larger number of races on which a successful bet has been placed together with the other user can be easily recognized.

[Supplementary Note 24] The information processing device according to Supplementary Note 23, in which the processor performs rearrangement on the third screen such that a region that displays a race venue with a large number of races on which both the first user and the second user have been successful in betting is positioned at an upper position relative to a region that displays a race venue with a small number of races on which both the first user and the second user have placed a successful bet.

In this manner, it is possible to provide a GUI with which a race venue with a larger number of races on which a successful bet has been placed together with the other user can be easily recognized.

An object of the present invention is to provide a GUI with which a race that can be bet by the user can be easily recognized.

[Supplementary Note 25] The information processing device according to Supplementary Note 23, in which the processor causes the terminal apparatus of the first user to display information about a race that is conducted at the specific race venue and can be bet by the first user.

In this manner, it is possible to provide a GUI with which a race that can be bet by the user can be easily recognized.

An object of the present invention is to provide a GUI with which a race similar to a race on which a successful bet has been previously placed together with the other user can be easily recognized.

[Supplementary Note 26] The information processing device according to Supplementary Note 25, in which the processor causes the terminal apparatus of the first user to display, in a recommendation form recommended to the first user, a race similar to a race on which both the first user and the second user have been successful in betting in the information stored in the storage among races that are conducted at the specific race venue and can be bet by the first user.

In this manner, it is possible to provide a GUI with which a race similar to a race on which a successful bet has been previously placed together with the other user can be easily recognized.

An object of the present invention is to provide a GUI that can easily motivate other users to bet.

[Supplementary Note 27] The information processing device according to Supplementary Note 23, in which when receiving a bet placed by the first user on a race conducted at the specific race venue, the processor causes a terminal apparatus of the second user to display the race bet by the first user and betting content information.

In this manner, it is possible to provide a GUI that can easily motivate other users to bet.

An object of the present invention is it is possible to provide a GUI with which whether the race bet by the user is bet by other users can be easily recognized.

[Supplementary Note 28] An information processing method according to the present embodiment includes, by a processor: causing a terminal apparatus of a first user to display a first screen, the first screen displaying a list of one or more races bet by the first user and including one or more display regions that respectively display one or more races bet by the first user, and controlling at least one of a display form and a display position of the one or more display regions based on whether the one or more races bet by the first user are bet by the second user in the information stored in a storage that stores information about one or more races bet by the first user and information about one or more races bet by a second user.

With the above-mentioned information processing method, it is possible to provide a GUI with which whether the race bet by the user is bet by other users can be easily recognized.

An object of the present invention is it is possible to provide a GUI with which whether the race bet by the user is bet by other users can be easily recognized.

[Supplementary Note 29] An information processing system according to the present embodiment includes: an information processing device including a processor and a storage; and a terminal apparatus used by a first user and connected to the information processing device to perform information communication with the information processing device, in which the storage stores information about one or more races bet by the first user and information about one or more races bet by a second user, and the processor causes a terminal apparatus of the first user to display a first screen, the first screen displaying a list of the one or more races bet by the first user and including one or more display regions that respectively display one or more races bet by the first user, and controls at least one of a display form and a display position of the one or more display regions based on whether the one or more races bet by the first user are bet by the second user in the information stored in the storage.

With the above-mentioned information processing system, it is possible to provide a GUI with which whether the race bet by the user is bet by other users can be easily recognized.

### REFERENCE SIGNS LIST

1 . . . Information Processing System, 10 . . . Server, 11 . . . Processor, 12 . . . Storage Apparatus, 13 . . . Communication IF, 14 . . . Input Device, 15 . . . Output Device, 20 . . . Terminal Apparatus, 20a . . . First Terminal Apparatus, 20b . . . Second Terminal Apparatus, 31 . . . Voluntary Bet Button, 32 . . . Bandwagon Bet Button, 33, 42 . . . Like Button, 34, 43 . . . Comment Entry Field, 41 . . . Detailed result display button, 51, 52 . . . Overview Information, 51a, 63 . . . Performance Information, 51b . . . Contestant Information, 51c . . . Comment Information, 61 . . . Race Archive, 62 . . . Basic Information, 64 . . . Comment, 65 . . . Tag Information, 66 . . . Response Information, 71 . . . Entry Field, 72 . . . Confirm Button, 73 . . . User Change Button, 74, 75, 76, 77, 78, 79 . . . Display Region, 100 . . . Storage Section, 100a . . . User Management DB, 100b . . . Group Management DB, 100c . . . Race History Management DB, 101 . . . Bet Screen Generation Section, 102 . . . Bet Information Acquiring Section, 103 . . . Posting Information Generation Section, 104 . . . Response Acquiring Section, 105 . . . Provision Section, 106 . . . Management Section

1. An information processing device comprising:
a processor; and
a storage, wherein
the storage stores information about one or more races bet by a first user and information about one or more races bet by a second user, and
the processor
causes a terminal apparatus of the first user to display a first screen, the first screen displaying a list of the one or more races bet by the first user and including one or more display regions that respectively display one or more races bet by the first user, and
controls at least one of a display form and a display position of the one or more display regions based on whether the one or more races bet by the first user are bet by the second user in the information stored in the storage.

2. The information processing device according to claim 1, wherein the processor controls at least one of the display form and the display position of the one or more display regions based on whether both the first user and the second user have been successful in betting on the one or more races bet by the first user in the information stored in the storage.

3. The information processing device according to claim 1, wherein the processor
causes the terminal apparatus of the first user to display a second screen for selecting the second user from among a plurality of users, and
specifies the second user based on an input operation on the second screen.

4. The information processing device according to claim 1, wherein the processor
causes the terminal apparatus of the first user to display a third screen that displays a list of race venues where the one or more races bet by the first user have been conducted, and
causes the terminal apparatus of the first user to display, based on an input operation on the third screen, information about a race conducted at a specific race venue specified by the input operation.

5. The information processing device according to claim 4, wherein the processor performs rearrangement on the third screen such that a region that displays a race venue with a large number of races on which both the first user and the second user have been successful in betting is positioned at an upper position relative to a region that displays a race venue with a small number of races on which both the first user and the second user have been successful in betting.

6. The information processing device according to claim 4, wherein the processor causes the terminal apparatus of the first user to display information about a race that is conducted at the specific race venue and can be bet by the first user.

7. The information processing device according to claim 6, wherein the processor causes the terminal apparatus of the first user to display, in a recommendation form recommended to the first user, a race similar to a race on which both the first user and the second user have been successful in betting in the information stored in the storage among races that are conducted at the specific race venue and can be bet by the first user.

8. The information processing device according to claim 4, wherein when receiving a bet placed by the first user on a race conducted at the specific race venue, the processor causes a terminal apparatus of the second user to display the race bet by the first user and betting content information.

9. An information processing method comprising, by a processor:
causing a terminal apparatus of a first user to display a first screen, the first screen displaying a list of one or more races bet by the first user and including one or more display regions that respectively display one or more races bet by the first user; and
controlling at least one of a display form and a display position of the one or more display regions based on whether the one or more races bet by the first user are bet by the second user in the information stored in a storage that stores information about one or more races bet by the first user and information about one or more races bet by a second user.

10. An information processing system comprising:
an information processing device including a processor and a storage; and
a terminal apparatus used by a first user and connected to the information processing device to perform information communication with the information processing device, wherein
the storage stores information about one or more races bet by the first user and information about one or more races bet by a second user, and
the processor
causes a terminal apparatus of the first user to display a first screen, the first screen displaying a list of the one or more races bet by the first user and including one or more display regions that respectively display one or more races bet by the first user, and
controls at least one of a display form and a display position of the one or more display regions based on whether the one or more races bet by the first user are bet by the second user in the information stored in the storage.
